(19) United States
(12) Patent Application Publication
(10) Pub. No.: US 2018/0310133 A1
(43) Pub. Date: Oct. 25, 2018

(54) WIRELESS NETWORK POSITIONING

(71) Applicant: QUALCOMM Incorporated, San Diego, CA (US)

(72) Inventors: Bala RAMASAMY, San Diego, CA (US); Arnold Jason GUM, San Diego, CA (US); Naveen Kumar KAKANI, Irving, TX (US); Rahul MALIK, San Diego, CA (US)

(21) Appl. No.: 15/712,979

(22) Filed: Sep. 22, 2017

Related U.S. Application Data
(60) Provisional application No. 62/489,903, filed on Apr. 25, 2017.

(51) Int. Cl. H04W 4/02; H04W 64/00; H04W 88/08

(52) U.S. Cl. CPC H04W 4/025; H04W 84/12; H04W 88/08; H04W 64/003

(57) ABSTRACT

Disclosed embodiments facilitate efficient positioning of stations (STAs) one wireless networks. A method on an Access Point may determine, at a first time, availability of the Access Point (AP) for positioning; and transmit, based at least in part, on the determination, information indicative of the AP's availability for positioning. The transmitted information may comprise one or more of: STA-AP location determination availability, STA-AP location determination capability, whether AP-AP positioning is being performed; and/or the next scheduled AP-AP ranging session. In some embodiments, a STA may initiate location determination to determine a location of the STA based, at least in part, on indications of availability for positioning for one or more Access Points (APs) communicatively coupled to the STA. Each indication of availability may correspond to a distinct AP of the one or more APs, and the location determination may comprise either: STA-AP location determination, or passive location determination.

### CROSS REFERENCE TO RELATED APPLICATIONS

This application claims the benefit of and priority to U.S. Provisional Patent Application No.: 62/489,903 entitled “WIRELESS LOCAL AREA NETWORK POSITIONING,” filed Apr. 25, 2017, which is assigned to the assignee hereof and incorporated by reference in its entirety herein.

### FIELD

The subject matter disclosed herein relates to positioning in wireless communication systems and specifically to protocols for ranging, positioning, and/or direction finding in wireless communication systems.

### BACKGROUND

It is often desirable to perform positioning function on a user equipment (UE) or a Station (STA). The UE or STA may, for example, take the form of a mobile station, cell phone, wearable, handheld computing device, or some other user device. The terms “location” and “position” are synonymous and are used interchangeably herein. For example, in wireless systems based on the Institute of Electrical and Electronics Engineers (IEEE) 802.11 standard, positioning may be performed (e.g. using Round Trip Time (RTT)) measurements and/or Fine Timing Measurement (FTM)) between an Access Point (AP) and a STA.

In conventional Wireless Local Area Networks (WLANs), network congestion may detrimentally affect STA positioning. For example, network congestion may cause an AP to reject positioning requests from one or more STAs. When STA positioning requests are rejected, one or more STAs may retry the positioning request thereby potentially aggravating existing congestion. In other instances, the AP's response to STA positioning requests may be delayed thereby limiting the utility of the response. In addition, as the number of STAs increases, the traffic load from positioning and/or ranging measurements can increase substantially because each STA may perform ranging independently with a plurality of APs.

### SUMMARY

In some embodiments, a method at a Station (STA) may comprise: initiating a location determination method to determine a location of the STA based, at least in part, on indications of availability for positioning for one or more Access Points (APs) communicatively coupled to the STA, wherein each indication of availability corresponds to a distinct AP of the one or more APs, and the location determination method comprises at least one of: STA-AP location determination, or passive location determination.

In another aspect, a station (STA) may comprise: a transceiver, and a processor coupled to the transceiver, wherein the processor is configured to: initiate location determination to determine a location of the STA based, at least in part, on indications of availability for positioning for one or more Access Points (APs) communicatively coupled to the STA, wherein each indication of availability corresponds to a distinct AP of the one or more APs, and the location determination comprises at least one of: STA-AP location determination, or passive location determination.

In a further aspect, a station (STA) may comprise: means for initiating a location determination means to determine a location of the STA based, at least in part, on indications of availability for positioning for one or more Access Points (APs) communicatively coupled to the STA, wherein each indication of availability corresponds to a distinct AP of the one or more APs, and the location determination means comprises at least one of: STA-AP location determination means, or passive location determination means.

In some embodiments, a non-transitory computer-readable medium may comprise instructions to configure a processor on a station (STA) to: initiate a location determination method to determine a location of the STA based, at least in part, on indications of availability for positioning for one or more Access Points (APs) communicatively coupled to the STA, wherein each indication of availability corresponds to a distinct AP of the one or more APs, and the location determination method comprises either: STA-AP location determination, or passive location determination.

In some embodiments, a method at an Access Point (AP) may comprise: determining at a first time, the availability of an Access Point (AP) for positioning; and transmitting based at least in part, on the determination, information indicative of the AP's availability for positioning.

In some embodiments, the information indicative of the AP's availability for positioning may comprise at least one of: STA-AP location determination availability, or STA-AP location determination capability, or one or more parameters related to AP load, or whether AP-AP positioning is being performed; or the next scheduled passive AP-AP ranging session; or some combination thereof. The indication of availability of the AP for positioning may be transmitted in one or more management frames and/or HE packets.

In some embodiments, the availability of the AP for positioning may be determined based on network load, AP load and/or channel loads (for communication channels between AP 240 and communicatively coupled STAs). In some embodiments, the transmitted information indicative of the availability of the AP for positioning, may also be based, at least in part, on the determined AP load and/or may include information indicative of the AP load. In some embodiments, the transmitted information may include one or more management frames and/or HE packets with an indication of AP load.

The indication of network load, AP load, and/or channel load transmitted by an AP may be implicit or explicit. In some embodiments, the transmitted information indicative of the availability of the AP for positioning may indicate, based on network load, AP load, and/or channel load, availability or non-availability of one or more modes of positioning. In some embodiments, the transmitted information indicative of the availability of the AP for positioning may comprise one or more of: (a) an AP-AP performance field, indicating availability (or non-availability) of the AP for passive positioning; or (b) a scheduling field, indicating a scheduled time for a passive AP-AP ranging/position session; or (c) an STA-AP mode availability field, indicating availability (or non-availability) of the AP for STA-AP positioning; (d) an AP capability field, indicating positioning modes (STA-AP or AP-AP) currently supported by the AP.

In some embodiments, the indication of network load, AP load, and/or channel load transmitted by an AP may be (alternatively or additionally) provided through one or more parameters in a management, beacon, or probe response frame. In some embodiments, the one or more parameters may be specified in a Load Element and/or an extended Load Element in the management frame, beacon frame, and/or probe. response frame. In some embodiments, Load Element/extended Load Element may be specified in a Basic Service Set (BSS) Load Element, or a Quality of Service (QoS) Basic Service Set (QBSS) Load Element.

In embodiments where the availability of the AP for positioning is determined based on network load, AP load and/or channel loads (for communication channels between AP 240 and communicatively coupled STAs), the network load, AP load and/or channel loads may be determined based on one or more parameters including: the number of STAs communicatively coupled to the AP; or information pertaining to channel utilization or a channel load for a communication channel between the STA and AP, or an available admission capacity, a current available AP bandwidth; a current AP bandwidth utilization; a measure of network congestion; a pattern or history of AP load (e.g. based on time of day, and/or day of week) or some combination thereof. In some embodiments, the network load, AP load and/or channel loads may be determined, based, at least in part, on a historical pattern of AP utilization over a prior time period. In some embodiments, the network load, AP load and/or channel loads may be determined, based, at least in part, a function of the one or more of the one or more parameters above.

In some embodiments, in response to a determination that the AP load does not exceed a threshold, the information indicative of the AP's availability for positioning may specify that the STA-AP location determination is available, and in response to a determination that the AP load exceeds the threshold, the information indicative of the AP's availability for positioning may specify that STA-AP location determination is unavailable. In some embodiments, in response to a determination that the AP load exceeds the threshold, the information indicative of the AP's availability for positioning may specify a Scheduling field, indicating a scheduled time or for a passive AP-AP ranging/position session.

In some embodiments, in response to a determination that the network load, AP load and/or channel load does not exceed a threshold, the information indicative of the AP's availability for positioning may specify that STA-AP location determination is supported; and in response to a determination that the AP load exceeds a threshold, the information indicative of the AP's availability for positioning may specify that STA-AP location determination is unsupported. The indication of STA-AP location determination capability may be provided in a capabilities field comprised in at least one of: a beacon frame, or a management frame, or a probe response frame.

In some embodiments, when providing an indication of: non-availability of STA-AP positioning on the AP; or a lack of current support for STA-AP positioning on the AP, AP may not disable or turn off STA-AP positioning functionality.

In another aspect, an Access Point (AP) may comprise: a transceiver, and a processor coupled to the transceiver, wherein the processor is configured to: determine at a first time, the availability of an Access Point (AP) for positioning; and initiate transmission based at least in part, on the determination, information indicative of the AP's availability for positioning. In some embodiments, the information indicative of the AP's availability for positioning may comprise at least one of: STA-AP location determination availability, or STA-AP location determination capability, or one or more parameters related to AP load, or whether AP-AP positioning is being performed; or the next scheduled passive AP-AP ranging session; or some combination thereof. The indication of availability of the AP for positioning may be transmitted in one or more management frames and/or HE packets.

In a further aspect, an Access Point (AP) may comprise: means for determining at a first time, the availability of an Access Point (AP) for positioning; and means for transmitting based at least in part, on the determination, information indicative of the AP's availability for positioning. In some embodiments, the information indicative of the AP's availability for positioning may comprise at least one of: STA-AP location determination availability, or STA-AP location determination capability, or one or more parameters related to AP load, or whether AP-AP positioning is being performed; or the next scheduled passive AP-AP ranging session; or some combination thereof. The indication of availability of the AP for positioning may be transmitted one or more :management frames and/or HE packets.

In some embodiments, a non-transitory computer-readable medium may comprise instructions to configure a processor on an Access Point (AP) to: determine at a first time, the availability of an Access Point (AP) for positioning; and transmit based at least in part on the determination, information indicative of the AP's availability for positioning. In some embodiments, the information indicative of the AP's availability for positioning may comprise at least one of: STA-AP location determination availability, or STA-AP location determination capability, or one or more parameters related to AP load, or whether AP-AP positioning is being performed; or the next scheduled pass AP-AP ranging session; or some combination thereof. The indication of availability of the AP for positioning may be transmitted in one or more management frames and/or HE packets.

The methods disclosed may be performed by one or more of STAs, including AP STAs, and/or non-AP STAs using various protocols. Embodiments disclosed also relate to software, firmware, and program instructions created, stored, accessed, read, or modified by processors using computer-readable media or computer-readable memory.

### BRIEF DESCRIPTION OF THE DRAWINGS

Embodiments of the invention will be described, by way of example only, with reference to the drawings.

FIG. 1 shows a schematic block diagram illustrating certain exemplary features of a non-AP STA, shown as a UE, enabled to perform wireless communication and location determination functions.

FIG. 2 shows a simplified architecture of a wireless communication system 200 in accordance with certain embodiments presented herein.

FIG. 3 shows a schematic block diagram illustrating an AP or AP STA.

FIG. 4 is a diagram illustrating message flow for an example STA-AP ranging operation.

FIG. 5A shows a signal diagram of an example AP-AP ranging operation.

FIG. 5B shows a signal diagram of a passive positioning operation based on the ranging operation of FIG. 5A.

FIG. 6A shows an example management frame.

FIG. 6B shows an example high efficiency (HE) packet.

FIG. 7 shows an example flowchart for a method to facilitate STA location determination.

FIG. 8 shows an example flowchart for a method 800 to facilitate STA location determination.

FIG. 9 shows an example flowchart for a method to facilitate STA location determination.

FIG. 10 shows an example flowchart illustrating a method for STA ranging/position determination.

### DETAILED DESCRIPTION

The term station or “STA” may refer to a device with a Medium Access Control (MAC) identifier coupled to a wireless network. An STA may be viewed as a logical entity that is a singly addressable instance of a medium access control (MAC) and physical layer (PHY) interface to a wireless medium. STAs may be mobile or stationary. In some instances, in the description below, for ease of explanation, an STA may be referred to as an “initiator” or as a “responder” to distinguish an STA that initiates a sequence of events from an STA that responds to the initiated sequence. An “STA” may function as both an “initiator” and a “responder.”

An STA may take the form of Access Point STA (AP STA), which refers to APs that provide wireless connectivity to one or more non-AP STAs. An AP STA may be in communication with one or more non-AP devices and/or with other AP STAs. AP-STAs are also referred to herein as APs or AP/STAs. AP STAs may be at known locations and the APs and/or another network entity may transmit the locations of AP STAs to one or more STAs to facilitate STA location determination. In addition, AP STAs may periodically perform AP-AP ranging and/or position determination sessions to update or confirm their respective locations.

An STA may also take the form of a non-AP STA, which refers to devices such as a mobile station, cellular phone, or a computing device such as a wearable device, laptop, handheld, tablet etc., or another entity coupled to the wireless network. A non-AP STA is also referred to herein as a “user equipment” (UE) or UE STA. A UE/UE STA may take the form of a “mobile station” or a “mobile device” such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term UE is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. In some instances, a UE may also be capable of functioning as an AP-STA.

Disclosed embodiments facilitate positioning in wireless communication networks. In a set of wirelessly networked devices, disclosed embodiments facilitate positioning, ranging, and/or direction finding between two devices (e.g. one-to-one, such as STA-AP positioning) and/or multiple devices (e.g. multiple STAs that listen during AP-AP positioning sessions). The term “STA-AP positioning” refers to protocols (e.g. FTM) for position determination between one or more first STAs (e.g. non-AP STAs) and one or more second STAs (e.g. AP STAs). The term “AP-AP positioning” as used herein refers to positioning that may occur between two or more APs (e.g. between two or more AP STAs).

In passive location determination, one or more first UEs may listen to messages exchanged during an AP-AP or STA-AP positioning session occurring with other second UEs. Based on information in the messages (a) exchanged between the APs, and/or (b) exchanged between the APs and second UEs, and the known locations of the APs, one or more of the first listening UEs may determine their respective locations. Location determination by first STAs based on listening to AP-AP or STA-AP positioning sessions (e.g.) for other second STAs) may be considered passive in that no location determination requests are sent by the first STAs to the APs. In some instances, passive location determination may be used (e.g. by first STAs) when a network (e.g. a private network) restricts STA-AP positioning requests to authorized (e.g. second) STAs (e.g. by indicating availability for STA-AP positioning requests to unauthorized STAs). In some instances, passive location determination may be used when a network operator offers tiers of positioning services. For example, a first tier (e.g. higher priority tier or a higher paying tier) may have access to STA-AP positioning) while a second tier (e.g. a lower priority tier or a lower paying tier) may be able to use passive positioning based on periodic AP-AP positioning sessions or STA-AP positioning sessions by STAs in the first tier. Disclosed embodiments may facilitate positioning, ranging and/or direction finding using sounding frames (e.g. Null Data Packets (NDPs)), FTM frames, and/or other RTT measurements.

In some embodiments, positioning is facilitated through protocols or modifications to protocols that facilitate determination of: (i) AP availability for positioning (e.g. STA-AP and/or AP-AP positioning). In some embodiments, the AP's indication of availability for positioning may comprise information indicative of: availability of an STA AP positioning mode on the AP, or support for an STA-AP positioning capability on the AP, or availability of an AP-AP positioning mode on the AP, or support for an AP-AP positioning capability on the AP, or a current performance of AP-AP positioning by the AP, or a scheduled performance of AP-AP positioning on the AP, or some combination thereof. In some embodiments, support for passive positioning may be inferred by monitoring timing messages exchanged between APs. In some embodiments, the information indicative of AP availability for positioning may be comprised in a capabilities field specifying corresponding AP capabilities.

Disclosed embodiments may facilitate determination and/or communication of AP load or network load. The term “network load” refers to a measure of network resource utilization. Network load may be measured or inferred based on metrics such as expected response time to STA requests, the number of STAs coupled to the network, individual and aggregate AP loads, number of APs available to service requests, etc. The term “AP load” refers to a measure of resource utilization on an AP, such as number of STA requests within some time period, number of pending STA requests, current, average, or expected response times to STA requests, processor, memory, and/or network utilization etc. AP load may be indicated by one or more parameters such as one or more of: the number or count of STAs connected or communicatively coupled to the AP; or information pertaining to channel utilization for a communication channel between an STA and AP; or an available admission capacity; or a current available AP bandwidth; or a current AP bandwidth utilization; or a measure of network congestion; or some combination thereof. AP load may also be indicated by specific tasks performed by the AP and/or availability to perform those tasks and/or support for those tasks. In some embodiments, an indication of AP availability for positioning (e.g. STA-AP positioning, AP support for STA-AP positioning, performance of AP-AP positioning or a scheduled performance of AP-AP ranging/positioning session) may be based on a network load and/or AP load. In some embodiments, AP or network load may be inferred by the availability (or unavailability) of one or more APs on the network for STA-AP positioning and/or messages indicating support (or a lack of support) for STA-AP positioning.

In some embodiments, an AP may determine the availability of one or more positioning modes (e.g. STA-AP) based on one or more of: AP load, network load, channel load, and/or other signal environment parameters. For example, when network load or AP load exceeds some threshold, an AP may: disable STA-AP positioning, and/or indicate that STA-AP positioning is unavailable, and/or indicate a lack of support for STA-AP positioning during the period when the load exceeds, or is expected to exceed, the threshold. In some embodiments, the indication of AP load may be implicit or may be inferred by the existence of AP-AP timing messages. For example, one or more APs in a network may be programmed to send AP-AP timing messages when AP load, network load reach some threshold. As one example, when STA-AP positioning requests that are currently being processed reach some threshold, an AP may initiate transmission messages related to AP-AP positioning such as AP-AP timing message. In some embodiments, an AP may determine and/or communicate parameters related to network load/AP load, which may be used (e.g. by a UE) to determine the positioning mode (AP-AP or STA-AP) to be used (e.g. by the UE).

In some embodiments, an STA (e.g. UE STA) may initiate a location determination method to determine a location of the STA based, at least in part, on indications of availability for positioning for one or more Access Points (APs) communicatively coupled to the STA. Each indication of availability may correspond to a distinct AP and the location determination method (e.g. used by the STA) may comprise either: STA-AP location determination, or passive location determination. In some embodiments, the indication of AP availability for positioning received by the STA may comprise information indicative of: availability of an STA-AP positioning mode on the AP, or support for an STA-AP positioning capability on the AP, or availability of an AP-AP positioning mode on the AP, or support for an AP-AP positioning capability on the AP, or a current performance of AP-AP positioning by the AP, or a scheduled performance of AP-AP positioning on the AP, or some combination thereof. In some embodiments, support for passive positioning may be inferred by the STA monitoring timing messages exchanged between APs. In some embodiments, the information indicative of AP availability for positioning may be comprised in a capabilities field specifying corresponding AP capabilities.

In some embodiments, the indication of availability may be based on an AP load or network load. In some embodiments, an STA may determine or infer AP ability for positioning based on information transmitted by the AP. For example, the STA may read information in a Load Element field, and/or information related to AP load/network load that may be transmitted (e.g. broadcast) by an AP, to determine whether to request or initiate STA-AP positioning, or use AP-AP positioning. For example, when a UE determines (e.g. based on information transmitted by the AP) that the network load/AP load is high (e.g. exceeds some threshold), then, the UE may request AP-AP positioning and refrain from using STA-AP positioning. Conversely, when the UE determines (e.g. based on information transmitted by the AP) that the network load/AP load is lower (e.g. does not exceed some threshold), then, the UE may request STA-AP positioning. In some embodiments, an STA (e.g. UE) may infer the network load based on the presence of AP-AP timing messages. For example, when AP-AP timing messages are detected, an STA may infer that load is likely high and use passive positioning the AP-AP timing messages rather than issue RTT requests.

In some embodiments, an STA may determine a subset of APs that are proximate (e.g. based on Received Signal Strength Indicator (RSSI) level). Further, based on the desired positioning dimensionality (e.g. 2-dimensional (2D) or 3-dimensional (3D)), the STA may determine a threshold number of STAs for positioning (e.g. for STA-AP positioning). Based on the indications of availability of APs in the subset, the STA may determine if a threshold number of APs are available to process the positioning request (e.g. STA-AP positioning). If the threshold number of APs are available (e.g. 3 APs for a 2-dimensional positioning), for STA-AP positioning, then the STA may initiate STA-AP positioning. On the other hand, if the threshold number of APs are not available for STA-AP positioning, then the STA may initiate passive positioning.

An AP may transmit management frames including beacon frames and/or probe response frames. The term “management frame” as used herein may refer to beacon frames, probe response frames, or other types of management frames such as frame that enable STAs to establish and maintain communications with APs or AP STAs. In some embodiments, one or more bits in a data field, Operational Element (OE) field and/or an Information Element (IE) field (hereinafter referred to as “field”) in a management frame transmitted by an AP may be used to indicate whether an AP is available for positioning. The field may indicate whether the AP: (a) is available for STA-AP positioning and/or AP-AP positioning (e.g. at a current time or some specified time), and/or (b) whether the AP is performing and/or available to perform AP-AP positioning (e.g. at the current time or some specified time).

For example, at least one bit may be set (turned on) to indicate availability of the AP to perform STA-AP positioning and/or service STA positioning requests and the at least one bit may be reset (turned off) to indicate unavailability of the AP to: perform STA-AP positioning and/or to service STA positioning requests. As a another example, if a single bit is used to indicate AP availability for AP-AP positioning or STA-AP positioning, then the single bit may be toggled to indicate the currently available AP positioning mode (e.g. STA-AP positioning or AP-AP positioning). As a further example, if a plurality of bits are used, each bit or some combination of bits may be used to indicate a specific AP condition such as, for example, one or more of: current support for STA-AP positioning: STA-AP positioning availability; support for AP-AP positioning, AP-AP positioning availability, and/or a current or scheduled performance of AP-AP positioning, or some combination thereof, etc. Accordingly, the number of bits used may depend on the information being conveyed by the AP such as the number of positioning modes supported and availability/performance of those positioning modes.

In some embodiments, the availability of the AP for positioning may be based on network load and/or AP load. In some embodiments, the value of one or more bits (e.g. in a field) in a capabilities message sent by the AP may be set or changed to indicate that the AP: (a) lacks support for STA-AP positioning, or (b) is available for STA-AP positioning and/or supports STA-AP positioning; and/or (c) is capable of AP-AP positioning, and/or available to perform AP-AP positioning, and/or (d) is currently performing AP-AP positioning, and/or (e) has scheduled an AP-AP positioning session at some specified time. For example, based on AP load (e.g. when AP load exceeds some threshold), an AP may indicate that the AP; (a) is unavailable to perform STA-AP positioning, or lacks support for STA-AP positioning, and (b) is available for AP-AP positioning; and/or (c) is currently performing AP-AP positioning or has scheduled AP-AP positioning. As another example, based on AP load (e.g. when AP load does not exceed the threshold), an AP may indicate that the AP: (a) is available to perform STA-AP positioning and/or capable of performing STA-AP positioning. Accordingly, in some embodiments, the number of bits used to convey availability of an AP to service positioning requests may depend on the information being conveyed by the AP such as the number of positioning modes supported and availability/performance of those positioning modes under various network load/AP load conditions.

In some embodiments, the AP may determine or estimate network/AP load based on one or more of, (a) a number or count of STAs/devices connected or communicatively coupled to the AP; (b) historical network usage (e.g. time of day, stored usage patterns, etc.), and/or AP utilization patterns; (c) available AP and/or network bandwidth; (d) current or expected AP/network bandwidth utilization; (e) a measure of network congestion; (f) channel load; and/or (g) some combination thereof. In some embodiments, the AP may change one or more of: its availability for STA-AP positioning and/or support for STA-AP positioning based on the determined or estimated network/AP load. In some embodiments, the AP may monitor one or more of the parameters (a)-(f) above and may periodically re-determine AP availability to perform STA-AP positioning and/or service STA positioning requests. The AP may update the indication of availability of the AP to perform STA-AP positioning and/or to service STA positioning requests based on the re-determination. For example, the AP may change the availability of one or more positioning modes (e.g. enable a previously disabled STA-AP positioning mode or indicate support for STA-AP positioning) when one or more of the parameters above change (e.g. decrease in network congestion, a decrease in the number of UEs associated with the AP, change in time of day, etc.). The transmissions by the AP may be broadcast, multicast, or unicast.

In the description, the term “unicast” is used to indicate transmission of signals from an AP/STA to a single device, whereas the term “multicast” is used to indicate transmission of signals from an AP/STA to a plurality of devices. The term “broadcast” is used to refer to transmission of signals from an AP/STA to all devices authorized to and/or capable of receiving the transmitted signal. The term “transmit” may refer to unicast, multicast, or broadcast.

In some embodiments, a UE/STA may receive or listen to message transmitted by an AP. The message (e.g. one or more fields in a management frame) may indicate whether the AP: (i) is available to perform STA-AP positioning and/or supports STA-AP positioning; and/or (ii)is available to perform AP-AP positioning; and/or (iii) whether the AP is currently performing AP-AP positioning, and/or (iv) whether the AP is scheduled to perform AP-AP positioning.

In some embodiments, based on the message, the UE may either request/perform STA-AP positioning (e.g. if the AP indicates support for STA-AP positioning and/or availability of STA-AP positioning), or perform passive positioning (e.g. if the AP indicates a lack of support for STA-AP positioning and/or a unavailability of STA-AP positioning and/or that AP-AP positioning is currently being performed). For example, if the AP indicates that it is currently performing AP-AP positioning, or AP-AP positioning has been scheduled within some time period of the current time then the UE may perform passive positioning by sniffing or listening to AP-AP positioning messages. In some embodiments, the UE may also perform passive positioning by sniffing or listening to STA-AP positioning messages for other STAs/UEs. On the other hand, if the AP is capable of STA-AP positioning and is available to perform STA-AP positioning, then the UE may perform STA-AP positioning to determine its location.

In some embodiments, the UE/STA may listen to a BSS Load element frame (e.g. to determine the number of stations currently associated with an AP, channel utilization for available channels, channel load, available admission capacity, etc.) or some other indication of AP/network traffic to determine an AP load or network load. In some embodiments, the BSS Load Element or similar IE may be transmitted by an AP STA as part of a probe response frame or another WLAN management frame. In some embodiments, increased AP load or network load may be indicated by the AP by indicating a temporary disabling of STA-AP positioning.

If the AP load, as determined by the UE (e.g. based on values of one or more of the above parameters) exceeds a threshold, or if the AP indicates that STA-AP positioning is unavailable or unsupported, then, the UE/STA may determine to use passive positioning and may determine its position by listening to AP-AP positioning messages. In the example above, if the UE/STA is unable to determine its position based on passive AP-AP positioning within some time period, then the UE/STA may request or initiate STA-AP positioning (when available) and determine its position based on STA-AP positioning. For example, upon expiry of the time period, the UE may initiate an STA-AP positioning request (e.g. when the AP indicates STA-AP positioning is available).

In modern wireless systems, multiple antennas at the transmitter and receiver may be used to implement multiple input/multiple output (MIMO). MIMO facilitates parallel delivery of multiple spatially multiplexed data signals, which are referred to as multiple spatial streams. Further, in multi-user MIMO (MU-MIMO), an AP may simultaneously transmit to multiple client UEs and beamforming may be used for directional signal transmission or reception. In MU-MIMO, the term “downlink” refers to communication, which may occur in parallel, from an AP (e.g. transmitted by the AP) to one or more STAs, while the term “uplink” refers communication, which may occur in parallel, to an AP (received by the AP) from one or more STAs.

The term “Angle of Arrival” (AoA) refers to a direction of propagation of a radio-frequency wave incident on an antenna array relative to orientation of the antenna array. As one example, AoA may be determined based on the Time Difference of Arrival (TDOA) or phase difference measurements of a radio wave received at individual elements of an antenna array. Conversely, the term “Angle of Departure” (AoD) refers to a direction of propagation of a radio-frequency wave transmitted from an antenna array relative to orientation of the antenna array. In some embodiments, AoA and AoD may be determined by an STA based on signals exchanged with another STA. For example, an STA, such as a receiver, may resolve AoA and AoD based on signals exchanged with another STA.

The term “Fine Timing Measurement” (FTM) refers to a message exchange protocol that may be used for positioning. FTM involves the exchange of FTM frames for range determination. For example, an initiating STA (e.g. non-AP STA) may start an FTM session and exchange FTM frames with a responding STA (e.g. an AP STA). The initiating STA may measure the time-of-flight (TOF), which is given by the half the round trip delay. The initiating STA may determine its range based on exchanged frames, which may include timestamps corresponding to: (a) the departure time of the FTM frame from the initiating STA and (b) the arrival time of the FTM frames at the responding station (e.g. an AP) during an FTM session. In some embodiments, such as MIMO/MU-MIMO, parameters such as Angle of Arrival (AoA) and/or Angle of Departure (AoD) may also be used to determine STA position. FTM frames (e.g. from an initiator) may use a dialog token to identify a corresponding FTM/FTM Acknowledgment (e.g. from a responder). FTM frames may include timestamp measurements at the AP and/or at an STA. The timestamp measurements may be used for range calculation and/or position determination.

In some embodiments, one or more of: frame structure, and/or fields (OE/IE/data) in frames, broadcast messages, and/or message exchange protocols may be leveraged to determine one or more of (a) whether STA-AP positioning is available and/or whether an AP supports STA-AP positioning; and/or (b) whether AP-AP positioning is available and/or c) whether an AP is currently performing AP-AP positioning. In some embodiments, the disclosed techniques may be embodied in an application on an STA (e.g. an AP STA or a non-STA) as appropriate. The example message flows, frame formats, and/or information elements described herein may be compatible, in some respects with specifications, diagrams, and guidelines found in some IEEE 802.11 standards.

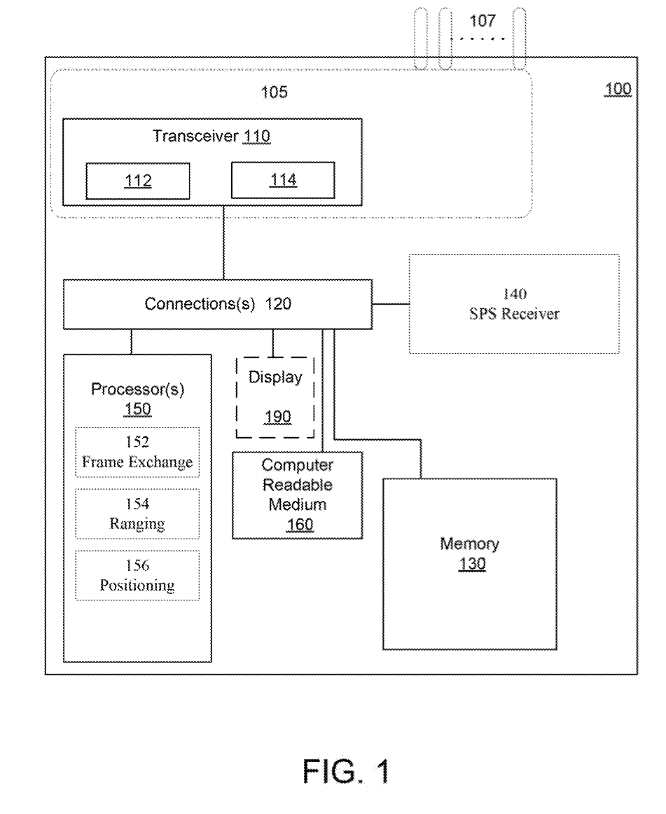

FIG. 1 shows a schematic block diagram illustrating certain exemplary features of a non-AP STA shown as UE 100 enabled to perform wireless communication and location determination functions. In some embodiments, UE 100 may take the form of a wearable user device, such as a wristwatch, spectacles, etc., where one or more functional components of UE 100 may be physically separate but operationally coupled to other functional components. For example, display 190 may be physically separate but operationally coupled processors(s) 150 and/or other functional units in UE 100.

UE 100 may include one or more processor(s) 150 and memory 130. UE 100 may also include a wireless network interface 105. In some embodiments, wireless network interface 105 may include transmitter 112 and receiver 114. In some embodiments, UE 100 may further comprise computer-readable medium 160 and display 190. The components above may be operatively coupled to each other with one or more connections 120 (e.g., buses, lines, fibers, links, etc.). In certain example implementations, all or part of UE 100 may take the form of a chipset, and/or the like. Further, UE may optionally include a screen or display 190 capable of rendering images of various types.

In some embodiments, UE 100 may include SPS receiver 140, which may receive signals from a Satellite Positioning System (SPS). A SPS may include a plurality of satellites 180 (also referred to as space vehicles (SVs)). Satellites 180 may be part of a Global Navigation Satellite System (GNSS), GNSS includes systems such as the US Global Positioning System (GPS), the European Galileo system, the Russian Glonass system or the Chinese Beidou system. In accordance with certain aspects, the techniques presented herein are not restricted to global, systems e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, and/or various augmentation systems (e.g., an Satellite Based Augmentation System (SBAS)) that may be associated with or otherwise enabled for use with one or more global and/or regional navigation satellite systems. UE 100 may also measure signals from satellites 180 and obtain pseudo-range measurements for the satellites.

In some embodiments, the signals received and measured by UE 100 timing information such as an absolute time reference and time reference uncertainty. For example, UE 100 may obtain a GNSS time and a GNSS time uncertainty. The absolute time reference may be Coordinated Universal Time (UTC) or a GNSS time scale used by a GNSS (e.g. Galileo, GPS, etc.). Although, the respective offsets of various GNSS time scales relative to UTC may be different, SPS/GNSS times typically maintain synchronization with UTC. Therefore, one time scale can be obtained based on another. In some embodiments, GNSS systems may also transmit a broadcast correction (e.g. GPS to Galileo Time Offset) to facilitate time scale conversions. In some embodiments, the absolute time reference and time reference uncertainty may be obtained (e.g. by UE 100) from a SPS resource such as one or more of: a Global Navigation Satellite System (GNSS) Real Time Clock (RTC) or GNSS system time (e.g. the UE may include and/or be coupled to an GNSS receiver), Code Division Multiple Access (CDMA) system time from LTE System Information Block 8 (SIB8) message (e.g. received through transceiver 110); or GNSS system time from LTE System Information Block 16 (SIB16) message (e.g. received through transceiver 110).

The signals received and/or measured by UE 100 may be used to obtain a GNSS position fix and determine a location of UE 100. For example, the pseudo-range measurements and/or timing measurements may be used to derive a position estimate for UE 100. In some embodiments, UE 100 may provide the location information (e.g. obtained using an SPS or by other methods) and/or the absolute time reference information and time reference uncertainty to another device/STA. For example, UE 100 may send the GNSS position fix, GNSS timing information, and GNSS timing uncertainty to another device/STA.

In some embodiments, processor(s) 150 may also receive input from transceiver 110, which may receive wireless signals through one or more antennas 107, which may be used for signal transmission and reception using MIMO/MU-MIMO. Transceiver 110 may, for example, include a transmitter 112 enabled to transmit one or more wireless signals over one or more types of wireless communication networks and a receiver 114 to receive one or more signals transmitted over one or more types of wireless communication networks. For example, transceiver 110 may be capable of communication with a Wireless Local Area Network (WLAN), which may be based on IEEE 802.11 standards, Wireless Personal Area Network (WPAN), which may be based on IEEE 802.15 standards and/or a Wide Area Network (WAN) based on one or more cellular communication standards.

Processor(s) 150 may be implemented using a combination of hardware, firmware, and software. In some embodiments, processor(s) 150 may perform position determination and/or location assistance functions based on information derived from independent wireless measurements by UE 100 (e.g. from received signals) or obtained from measurements by other STAs including AP STAs. In some embodiments, processor(s) 150 may include transceiver 110, and/or other components as part of a single chip, integrated circuit, or package.

Processor(s) 150 may use some or all of the received signals and/or information to perform ranging, direction finding, and/or determine the location of UE 100. The determined location may be relative (e.g. relative to one or more STAs such as APs) or absolute (e.g. coordinates such as latitude, longitude, and altitude) or civic (e.g. geographic name/location). For example, processor(s) 150 may use Time Difference of Arrival (TDOA), Round Trip Time (RTT), Fine Timing Measurement (FTM), Advanced Forward Link Trilateralation (AFLT), Received Signal Strength Indication (RSSI), and/or some combination of the above to determine or validate its location.

As one example, processor(s) 150 may determine, record, and/or receive: timestamps associated with a time of reception/arrival (TOA) and/or a time of transmission/departure (TOD of signals, which may be used to determine RTT and/or a distance between UE 100 and one or more other devices/STAs. Further, AoA, AoD, and other characteristics and parameters described herein may be used to determine or estimate a location/micro-location of devices communicating with UE 100. In some embodiments, the measurements and/or results obtained from measurements may be included in one or more frames (e.g. FTM frames) exchanged between two STAs, such as between UE 100 and another device in accordance with one or more protocols described herein. In some embodiments, processor(s) 150 may include one or more of UE frame exchange engine 152, UE ranging engine 154, and/or UE positioning engine 156.

UE frame exchange engine 152 may provide functionality to create, process, and exchange ranging frames (such as FTM frames, NDPs, response frames, and trigger frames) and other frames (such as data frames, control frames, and management frames) with other wireless devices/STAs.

UE ranging engine 154 may facilitate timestamp capture and processing, and/or facilitate estimation of time of arrival (TOA) information of frames exchanged during ranging operations. The TOA information may be used to determine time difference of arrival (TDOA) values based on the exchanged frames, and to determine differential distances between UE 100 and other STAs. In some embodiments, UE ranging engine 154 may provide functionality to: (a) obtain or determine passive ranging schedules of other wireless devices, exchange ranging capabilities with other wireless devices, and passively listen for frames exchanged between other wireless devices during ranging operations (e.g. during AP-AP or other STA-AP location determination sessions); and/or (b) to initiate and exchange ranging capabilities with other wireless devices (e.g. an AP STA), and to determine range and other related information during active ranging operations (e.g. during STA-AP location determination sessions).

In some embodiments, processor(s) 150 may also include a UE positioning engine 156 to determine the location of the UE 100 based on information (e.g. TDOA values, TOA values, AoA, AoD, differential distances, and location information of the other wireless devices), which may be obtained during active (e.g. STA-AP or passive (AP-AP) positioning sessions. UE positioning engine 156 may use information obtained during frame exchange, sounding, and ranging operation (e.g. by UE frame exchange engine 152 and UE ranging engine 154) to determine the location of UE 100. In some embodiments, UE 100 may receive location assistance information such as the location of one or more APs from a network entity such as a system controller, a server communicatively coupled to the UE, and/or one or more APs communicatively coupled to the UE.

In some embodiments, UE 100 and/or processor(s) 150 may initiate a location determination method to determine a location of the UE based on indications of availability for positioning received from one or more Access Points (APs) communicatively coupled to the STA. Each indication of availability may correspond to a distinct AP and the location determination method may comprise either: active UE-AP/STA-AP location determination by UE 100, or passive location determination. For example, in passive location determination, UE 100 and/or processor(s) 150 may determine the location of UE 100 by sniffing AP-AP positioning session message exchanges, or by sniffing STA-AP positioning session message exchanges for other STAs/UEs. In some embodiments, the indication of availability (of an AP) for positioning may comprises information indicative of: availability of an STA-AP positioning mode on the AP, or support for an STA-AP positioning capability on the AP, or availability of an AP-AP positioning mode on the AP, or support for an AP-AP positioning capability on the AP, or a current performance of AP-AP positioning by the AP, or a scheduled performance of AP-AP positioning on the AP, or some combination thereof. In some embodiments, the information indicative of support for the STA-AP positioning capability on an AP, or the information indicative of support for the AP-AP positioning capability on the AP may be comprised in a capabilities field specifying the corresponding AP's capabilities.

In some embodiments, the indication of availability (of an AP) for positioning may be based on AP load and/or network load and/or channel load. In some embodiments, UE 100 and/or processor(s) 150 may determine a load of an AP STA based on a BSS Load Element or another field (OE/IE/data) transmitted by the AP STA. In some embodiments, UE 100 and/or processor(s) 150 may determine or infer the load of an AP STA based on an indication of unavailability of STA-AP mode by the AP STA and/or an indication, by the AP, of a lack of support for STA-AP positioning. In some embodiments, if the AP load, as determined by the UE (e.g. based on values of one or more of the above parameters in the BSS Load Element IE), exceeds a threshold, or if the AP STA indicates that STA-AP positioning is unavailable/unsupported, then, the UE/STA may use passive positioning and may determine its position (e.g. using one or more of UE ranging engine 154 and/or UE positioning engine 156) passively by listening to AP-AP positioning messages or by listening to STA-AP positioning messages for other UEs/STAs.

If the UE/STA 100 is unable to determine its position based on passive positioning within some reference time period or reference threshold time, then the UE/STA 100 may request or initiate STA-AP positioning (if available) for UE/STA 100 and determine its position based on active STA-AP positioning. In some embodiments, the reference time period and/or the reference threshold time may be predetermined. For example, upon expiry of the time period, UE 100 may initiate an STA-AP positioning request (e.g. when the AP indicates STA-AP positioning is available).

In some embodiments, UE 100 and/or processor(s) 150 may determine a subset of APs that are proximate (e.g. based on RSSI levels that exceed some RSSI threshold). Further, based on the desired positioning dimensionality (e.g. 2D or 3D), UE 100 and/or processor(s) 150 may determine a threshold number of STAs for positioning (e.g. for active STA-AP positioning by UE 100). Based on the indications of availability received from APs in the subset, UE 100 and/or processor(s) 150 may determine if a threshold number of APs are available to process an STA-AP positioning request by UE 100. If the threshold number of APs are available (e.g. 3 APs for a 2D positioning), for STA-AP positioning, then STA-AP positioning may be initiated. On the other hand, if the threshold number of APs are not available for STA-AP positioning, then passive positioning (e.g. based on sniffing AP-AP positioning session messages or STA-AP positioning session messages for other UEs/STAs) may be used to determine the location of UE 100. In some embodiments, UE 100 and/or processor(s) 150 may infer the absence of STA-AP positioning availability based on access restrictions or authorization requests by a network operator and invoke passive positioning.

The elements and methodologies describe herein may be implemented by various means depending upon the application. For example, these elements and methodologies may be implemented in hardware, firmware, software, or any combination thereof. For example, for a hardware implementation, the processor(s) 150 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

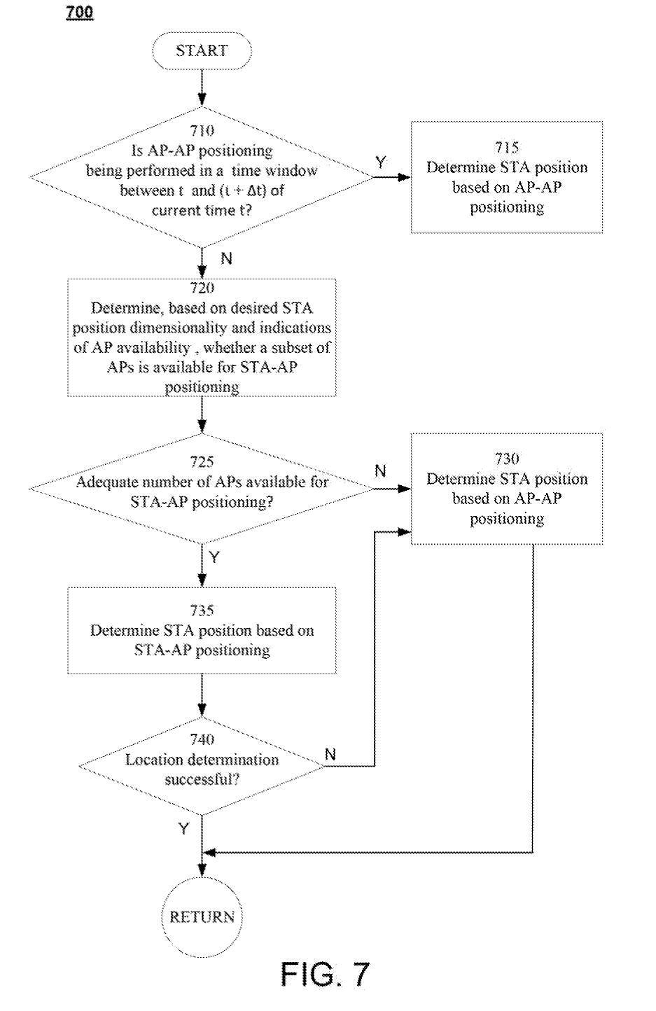

For a firmware and/or software implementation, the methodologies may be implemented using program code, microcode, procedures, functions, and so on that perform the functions described herein. Any machine-readable medium tangibly embodying instructions may be used in implementing the methodologies described herein. For example, program code, which may be stored in a computer-readable medium 160 and/or memory 130, may be read and executed by processor(s) 150 and may contain instructions for execution by the processor to perform any of the functionality described with reference to FIGS. 7, 8, 9, and 10.

Memory may be implemented within processor(s) 150 or external to processor(s) 150. As used herein, the term “memory” refers to any type of long term, short term, volatile, nonvolatile, or other memory and is not to be limited to any particular type of memory or number of memories, or type of media upon which memory is stored. Memory 130 may include, for example, a primary memory and/or a secondary memory. Primary memory may include, for example, a random access memory, read only memory, etc. While illustrated in this example as being separate from processor(s) 150, it should be understood that all or part of a primary memory may be provided within or otherwise co-located/coupled with processor(s) 150. If implemented in firmware and/or software, the functions may be stored as one or more instructions or program code on a computer-readable medium, such as medium 160 and/or secondary memory. Examples include computer-readable media encoded with computer programs and data associated with or used by the program.

Computer-readable medium 160 includes physical computer storage media, which may be accessed by a computer. In some embodiments, computer-readable medium 160 may include various types of memory 130 that may be read and/or accessed by UE 100 and/or processor(s) 150. By way of example, and not limitation, such computer-readable media can comprise one or more of the following: Random Access Memory (RAM), Read Only Memory (ROM), Programmable ROM (PROM), Electrically Erasable PROM (EEPROM), Non-Volatile Random Access Memory (NVRAM), flash memory, Compact Disc ROM (CD-ROM), or other optical disk storage, magnetic disk storage or other magnetic storage devices, or any other medium that can be used to store desired program code in the form of instructions and/or data and that can be accessed by a computer. The terms “disk” and “disc,” as used herein, includes compact disc (CD), laser disc, optical disc, digital versatile disc (DVD), floppy disk, and blue-rays disc where disks usually reproduce data magnetically, while discs reproduce data optically with lasers. Combinations of the above should also be included within the scope of computer-readable media. In some embodiments, computer-readable medium 160 may include instructions for execution by the processor comprising instructions to perform any of the functionality described with reference to FIGS. 7, 8, and 10.

For example, the computer-readable medium including program code stored thereon may include program code to support wireless communication including sounding, ranging, and position determination in a MIMO/MU-MIMO environment in accordance with certain embodiments presented herein. For example, the code may support one or more of AFLT/RTT/RSSI/Reference Signal Time Difference (RSTD)/TDOA/AoA/AoD, and other location determination techniques. In some embodiments, the program code may further support wireless channel characterization. For example, the computer-readable medium 160 including program code stored thereon may include program code to support wireless communication (including unicast, multicast, and broadcast), and/or sounding, ranging, positioning, and wireless medium characterization (including in a MIMO/MU-MIMO) environment in accordance with certain embodiments presented herein.

In some embodiments, instructions and/or data may be provided over a communication channel. For example, a communication apparatus may include a transceiver 110, which may receive signals through receiver 114 indicative of instructions and data. The instructions and data may cause one or more processors to implement wireless communication and/or wireless channel characterization (e.g. in a MU-MIMO environment), including ranging and/or position determination. The instructions and data may also cause one or more processors to implement functions outlined herein.

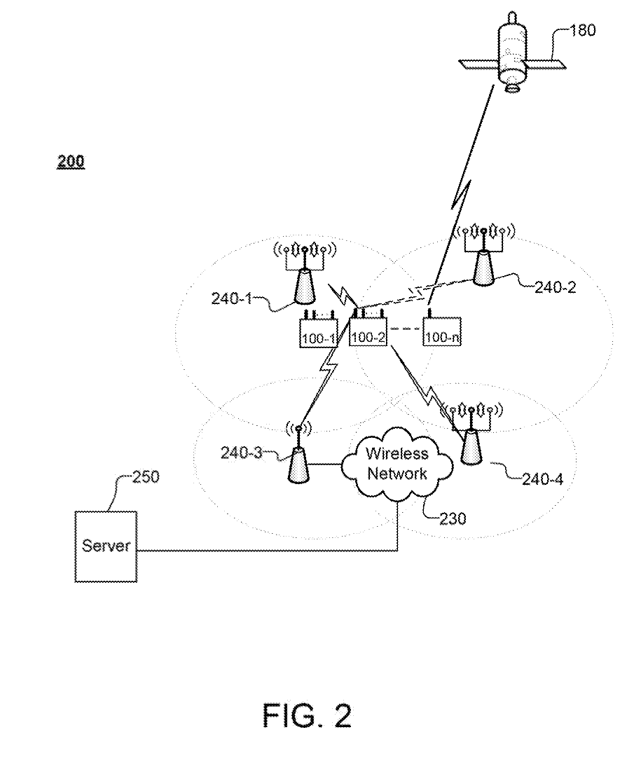

FIG. 2 shows a simplified architecture of a wireless communication system 200 in accordance with certain embodiments presented herein. System 200 may include non-AP STAs such as UEs 100-1 through 100-n (collectively referred to as UEs 100), and AP STAs such as APs 240-1 through 240-4 (collectively referred to as APs 240), which may communicate over a wireless communication network 230. In some embodiments, wireless communication network 230 may take the form of and/or may include one or more wireless local area networks (WLANs). In some embodiments, UEs 100 and/or APs 240 may communicate with server 250 over wireless communication network 230. While system 200 illustrates some UEs 100 and APs 240, the number of UEs 100 and APs 240 in a wireless communication network (e.g. a WLAN) may be varied in accordance with various system parameters. In general, system 200 may include a smaller or larger number of UEs 100 and/or APs 240.

In some embodiments, as outlined above, UE 100 may receive, measure and decode signals from one or more SVs 180 and thereby, as is well known in the art, obtain a position fix, an accurate absolute time reference (such as GPS time, Coordinated Universal Time (UTC) or a time for another GNSS which may be accurate to 50 nanoseconds (ns) or better in some embodiments) and a timing reference uncertainty. In some embodiments, the GNSS position fix, absolute time reference and/or absolute time synchronization information (e.g. GPS time, GNSS time, or UTC time) and timing reference uncertainty may be provided (e.g. by one or more UEs 100) to APs 240 by sending signaling information to APs 240 that includes a time reference such as using, for example, the Internet Network Time Protocol (NTP), IEEE 1588 Precision Time Protocol (PTP) and/or ITU-T Synchronous Ethernet. In some embodiments, APs 240, which receive the position fix, absolute time reference and time reference uncertainty information, may optionally, modify the time reference uncertainty information to account for other inaccuracies and/or processing delays. In some embodiments, the absolute time and time reference uncertainty information may be modified by APs 240 based on the distance of UE 100 from AP 240. which may be determined from the position fix. For example, APs 240 may modify time reference uncertainty to adjust for Short Interframe Spacing (SIFS) delays, if appropriate. The terms “SIFS interval” or “SIFS delay” may refer to an amount of time (e.g. in microseconds) it takes for a wireless interface to process a received frame and to respond with a response frame, A SIFS interval may consist of the time delay arising from receiver radio frequency (RF) processing, Physical Layer Convergence Procedure (PLCP) delay and the Medium Access Control (MAC) processing delay, which may depend on the physical layer used.

In some embodiments, APs 240 and/or UEs 100 that are synchronized to or have access to a common time reference may transmit or re-transmit (unicast, multicast, or broadcast) the common time reference and time reference uncertainty to other STAs or devices on network 230. For example, an AP 240 synchronized to an absolute timing reference may transmit the timing reference and timing uncertainty information to other devices. As another example, a UE 100 may demodulate the Time Of Week (TOW) header to obtain an absolute (e.g. GNSS) time reference. In some embodiments, the UE 100 may send the absolute time reference and timing reference uncertainty to one or more APs 240. Further, the timing reference and timing uncertainty may be requested by and/or provided to one or more UEs 100 that do not have access to the absolute timing reference source.

In instances where one or more APs 240 experience clock degradation, maintaining timing synchronization by APs 240 may be facilitated by the timing information received by the APs 240 from UEs 100. In some embodiments, APs 240 may use the absolute time reference (e.g. GNSS time) for measurements and/or time stamps. For example, packets or frames sent or received by APs 240 may be timestamped using the absolute time reference. In some embodiments, multiple APs 240 on network 230 may be synchronized to a common absolute time reference (e.g. to GNSS time) via timing information received from UEs 100 to obtain a quasi-synchronous network.

In some embodiments, (e.g. in quasi-synchronized networks), APs 240 may estimate one way delay for packets received from another device based on the timestamp indicating the time the packet was sent and time that the packet was received at AP 240. In embodiments where one or more UEs 100 may also be synchronized to the absolute time reference (bounded by the timing reference uncertainty), then, APs 240 that are also synchronized to the absolute time reference may estimate one way delay for packets (with the timing uncertainty) received from synchronized UEs 100 based on the timestamp indicating the time the packet was sent and time that the packet was received at AP 240. Conversely, a UE 100 may also estimate one-way delay for packets received from APs 240 that are synchronized to the common absolute time reference.

In some embodiments, one or more UEs 100 and/or APs 240 in system 200 may comprise multiple antennas and may support MIMO and/or MU-MIMO. UE 100 may receive and measure signals from APs 240, which may be used for position determination. In some embodiments, APs 240 may form part of a wireless communication network 230, such as a WLAN. For example, a WLAN may be an IEEE 802.11x network. Further, system 200 may comprise or take the form of: an Extended Service Set (ESS) network, which may comprise a plurality of appropriately configured BSS networks, an Independent Basic Service Set (IBSS) network, an ad-hoc network, or a peer-to-peer (P2P) network (e.g. operating according Wi-Fi Direct or similar protocols).

In some embodiments, system 200 may support orthogonal frequency-division multiple access (OFDMA.) communications (e.g. conforming to the IEEE 802.11ax specification or variants thereof. OFDMA may facilitate multiple STAs to transmit and receive data on a shared wireless medium at the same time. For a wireless network using OFDMA, the available frequency spectrum may be divided into a plurality of resource units (RUs) each with a number of different frequency subcarriers, and distinct RUs may be assigned (e.g. by AP 240) to various wireless devices (e.g. UEs 100) at a given point in time. Accordingly, OFDMA may facilitate concurrent transmission of wireless data by multiple wireless devices over the wireless medium using their assigned RUs. In some implementations, an AP may use a specific type of frame (such as a “trigger frame”) to allocate specific RUs to a number of wireless devices identified in the trigger frame. The trigger frame may indicate the RU size and location, power level, and other parameters to be used by identified wireless devices for uplink (UL) transmissions. In some embodiments, the AP may also use a trigger frame to solicit uplink (UL) multi-user (MU) data transmissions from wireless devices identified in the trigger frame. In some instances, the trigger frame may indicate or specify an order for identified wireless devices are to transmit UL data to the AP.

In some embodiments, one or more UEs 100 and APs 240 may communicate over wireless communication network 230, which may be based on IEEE 802.11 or compatible standards. In some embodiments, UEs 100 and APs 240 may communicate using variants of the IEEE 802.11 standards. For example, UEs 100 and APs 240 may communicate using 802.11ac on the 5 GHz band, which may support multiple spatial streams including MIMO and MU-MIMO and. In some embodiments, UEs 100 and APs 240 may communicate using some of the above standards, which may further support one or more of Very High Throughput (VHT) (as described in the above standards) and High Efficiency WLAN (HEW), and/or beamforming with standardized sounding and feedback mechanisms. In some embodiments, UEs 100 and or APs 240 may additionally support legacy standards for communication with legacy devices.

In some embodiments, an AP 240 may determine is availability for positioning at a first time and may transmit, based on the determination, information indicative of the AP's availability for positioning. The information indicative of the AP's availability for positioning may comprise at least one of: AP availability for STA-AP location determination, or STA-AP location determination capability, or whether AP-AP AP positioning is being performed; or the next scheduled passive AP-AP ranging session; or some combination thereof.

In some embodiments, the availability of AP 240 for positioning at a first time may be determined based on AP load or network load or channel load. For example, APs 240, which may form part of wireless communication network 230, may transmit management frames, which may include network related information. APs 240 may transmit (broadcast) management (e.g. beacon) frames periodically (e.g. every 100 ms) to announce the WLAN. For example, management frames, such as beacon frames, may include capability information, supported data rates, identification of network type (e.g. as an infrastructure network), a service set identifier (SSID) and/or a basic service set identifier (BSSID). In some embodiments, APs 240 may transmit a BSS Load element frame (e.g. with information related to the number of stations currently associated with an AP, channel utilization for available channels, available admission capacity, etc.), which may provide information on parameters related to AP load. In some embodiments, the BSS Load Element or similar IE may be transmitted by an AP 240 as part of a probe response frame or another WLAN management frame.

Conventionally, network congestion may detrimentally affect STA positioning. For example, network congestion may cause an AP 240 to reject positioning requests from one or more UEs 100. When STA positioning requests are rejected, one or more UEs 100 may retry the positioning request thereby potentially aggravating existing congestion. In other instances, the response to STA/UE 100 positioning requests may be delayed (e.g. by a responding STA/AP 240) thereby limiting the utility of the response. In addition, as the number of STAs associated with an AP increases, the ranging (RTT/FTM) measurements may consume significant system and network resources. For an AP with a high load relative to capacity, additional STA-AP positioning requests from UEs may aggravate congestion and detrimentally affect performance.

Accordingly, in some embodiments, the availability of AP 240 for positioning at a first time may be determined based on AP load or network load or channel load. As one example, one or more APs 240 may transmit information indicative of AP load or network load or channel load. For example, an AP 240 may provide information indicative of AP load in a BSS Load Element and/or another Field (e.g. in a management frame) field. As another example, an AP 240 may implicitly indicate higher AP load by disabling STA-AP positioning. As a further example, AP 240 may implicitly indicate lower AP load by signaling availability for STA-AP positioning. AP load, and/or network load and/or channel load related information may also be implicitly indicated by temporarily indicating that AP 240 lacks support for STA-AP positioning or lacks STA-AP positioning capability. For example, capability information transmitted by APs 240 may be temporarily altered to indicate a lack of support STA-AP positioning. Further, the capability information may (additionally or alternatively) indicate support for AP-AP positioning and/or indicate performance (e.g. at a current time or some scheduled time) of AP-AP positioning.

In some embodiments, UE 100 and/or processor(s) 150 may initiate a location determination method to determine a location of the UE based on indications of availability for positioning received from one or more Access Points (APs) communicatively coupled to the STA. Each indication of availability may correspond to a distinct AP and the location determination method may comprise either: active UE-AP/STA-AP location determination by UE 100, or passive location determination. For example, in passive location determination UE 100 and/or processor(s) 150 may determine the location of UE 100 by sniffing AP-AP positioning session message exchanges, or by sniffing STA-AP positioning session message exchanges for other STAs/UEs. In some embodiments, the indication of availability (of an AP) for positioning may comprises information indicative of: (i) availability of an STA-AP positioning mode on the AP, or (ii) support for an STA-AP positioning capability on the AP, or availability of an AP-AP positioning mode on the AP, or (iii) support for an AP-AP positioning capability on the AP, or (iv) a current performance of AP-AP positioning by the AP, or (v) a scheduled performance of AP-AP positioning on the AP, or some combination thereof. In some embodiments, the information indicative of support for the STA-AP positioning capability on an AP, or the information indicative of support for the AP-AP positioning capability on the AP may be comprised in a capabilities field specifying the corresponding AP's capabilities.

In some embodiments, UEs 100 may determine or infer a network load and/or AP load and/or channel load based on (i)-(v) above. In some embodiments, UE 100 may determine a network load and/or AP load and/or channel load based, in part, on: (i) parameters in a BSS Load Element and/or in other fields transmitted by the AP (e.g. in a management frame) Further, based on the AP positioning availability information and/or inferred/determined network/AP/channel load, one or more UEs 100 may request AP-AP positioning, or STA-AP positioning. For example, when the network load (e.g. as determined by UEs 100) is high or exceeds some threshold, or one or more APs signal unavailability or a lack of support for STA-AP positioning, then, UEs 100 may determine their respective position based on passive positioning. In some embodiments, UEs 100 may determine position by requesting and performing STA-AP positioning when AP/network/channel load is low, or APs 240 indicate support for STA-AP positioning and/or availability of STA-AP positioning at a current time (or at some specified time). For example, if the AP load or network load (e.g. as determined by UEs 100) indicates that AP load is low or does not exceed the threshold, or, if one or more APs 240 signal availability or support for STA-AP positioning, then STAs/UEs 100 may request STA-AP positioning and determine their respective positions actively by requesting STA-AP positioning.

In some embodiments, UEs 100 and/or APs 240 may be coupled to one or more additional networks, such as a cellular carrier network, a satellite positioning network, WPAN access points, and the like (not shown in FIG. 2). In some embodiments, UEs 100 and/or APs 240 may be coupled to a wireless wide area network (WWAN) (not shown in FIG. 2), A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), WiMax, and so on.

A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM, W-CDMA, and LTE are described in documents from 3GPP. Cdma2000 is described in documents from a consortium named “3rd Generation Partnership Project 2” (3GPP2). 3GPP and 3GPP2 documents are publicly available.

As illustrated in FIG. 2, UE 100 may also communicate with server 250-1 through wireless communication network 230 and APs 240, which may be associated with wireless communication network 230. In some embodiments, APs 240 and/or UE 100 may receive location assistance, network traffic, network load, and/or other network related information from server 250-1, which, in some instances, may be relayed to UEs 100 through one or more APs 240. In some embodiments, server 250-1 may serve as a system controller and may interface with other less and/or wired networks, and/or facilitate communication between devices coupled to system 200 and devices on another work.

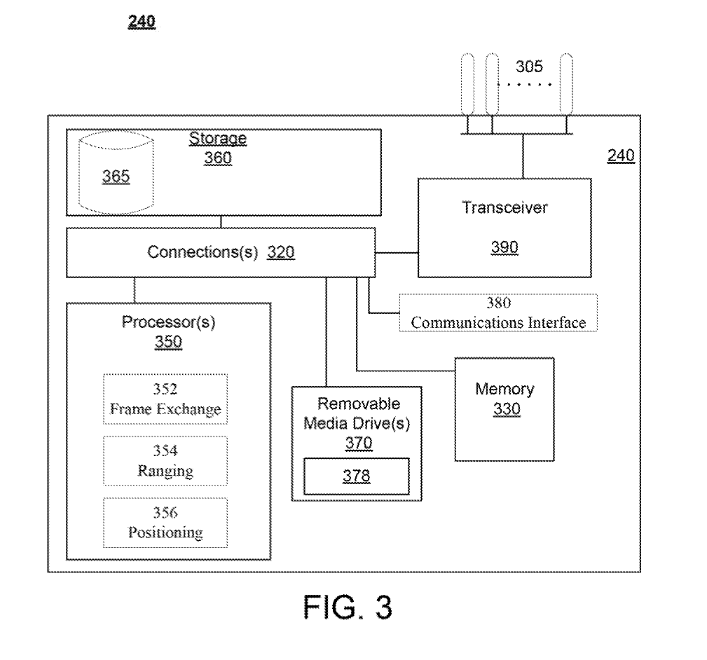

FIG. 3 shows a schematic block diagram illustrating AP 240 (or an AP STA). In some embodiments, AP 240 may be enabled to perform wireless communication (including unicast, multicast, and broadcast) and sounding, ranging, positioning, and wireless medium characterization operations. For example, the above operations may be performed in a MIMO/MU-MIMO environment in accordance with certain embodiments presented herein. In some instances, a UE 100 may also serve as an AP 240.

In some embodiments, AP 240 may include, for example, one or more processor(s) 350, memory 330, coupled storage 360, and transceiver 390, which may be operatively coupled with one or more connections 320 (e.g., buses, lines, fibers, links, etc.). Transceiver 390 may be capable of communication with a Wireless Local Area Network (WLAN), which may be based on the IEEE 802.11 standard (or variants thereof), Wireless Personal Area Network (WPAN, which may be based on IEEE 802.15 and/or a Wide Area Network (WAN) based on one or more cellular communication standards. In some embodiments, transceiver 390 may be coupled to one or more antennas 305, which may be used for signal transmission and/or reception using MIMO MU-MIMO. In some embodiments, AP 240 may also interface with wired networks through communications interface 380. AP 240 may transmit information such as service set identifiers (SSIDs), basic service set identification (BSSID) network identifiers, and/or timing information, which may be stored in memory 330 and/or obtained over communications interface 380.

AP 240 may periodically broadcast management frames (e.g. beacon frames), which may facilitate establishment and maintenance of communications with one or more STAs. In some embodiments, management frames, such as beacon frames, may be broadcast according to a target beacon transmission time (TBTT) schedule and may include a timing synchronization function (TSF) value or AP 240, STAs receiving the beacon frame may synchronize their respective local TSF values with the broadcast TSF value. Accordingly, STAs coupled to AP 240 may be synchronized with each other and with AP 240. In some embodiments, one or more of the beacon frames may include or announce a passive ranging schedule indicating timing and channel information related to the initiation of, or response to, ranging operations by AP 240. STAs coupled to AP 240 may listen to and receive frames exchanged during the ranging operations to passively determine their respective locations. In some embodiments, one or more fields in management frames (e.g. beacon frames) may be used to signal parameters related to AP load and/or network load. In some embodiments, STAs receiving the management frames may use the information to determine an AP load and/or network load. Based on the determined network load, STAs may request STA-AP positioning (e.g. if the AP load does not exceed some threshold), or use passive AP-AP positioning to determine their respective locations (e.g. if the AP load exceeds the threshold).

Processor(s) 350 may be implemented using a combination of hardware, firmware, and software, or any combination thereof. For a hardware implementation, the processor(s) 350 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. For a firmware and/or software implementation, the methodologies may be implemented using procedures, functions, and so on that perform the functions described herein.

Processor(s) 350 may use some or all of the received information to generate TDOA, RTT, RSSI, Range, AOA, AOD, Azimuth, and other channel characterization information in accordance with certain with disclosed embodiments.

In some embodiments, processor(s) 350 may comprise one or more of: an AP frame exchange engine 352, AP ranging engine 354, AP positioning engine 356, and AP scheduling engine 358.

AP frame exchange engine 352 may create, process, and exchange ranging frames (such as FTM frames, NDPs, response frames, and trigger frames,) and other frames (such as data frames, control frames, and management frames) between the AP 240 and other wireless devices/STAs (e.g. AP STAs and/or non-AP STAs). In some embodiments, AP frame exchange engine 352 may receive absolute time reference information (e.g. from a UE 100), time reference uncertainty information, and position information (e.g. pertaining to a position of UE 100). The absolute time reference and/or absolute time synchronization information and time reference uncertainty information may be provided (e.g. by one or more UEs 100) to APs 240 by sending signaling information to APs 240 that includes a time reference such as using, for example, the Internet Network Time Protocol (NTP), IEEE 1588 Precision Time Protocol (PTP) and/or an ITU-T Synchronous Ethernet.

In some embodiments, AP 240 (e.g. AP ranging engine 354) may use the received absolute time reference information (e.g. GPS time, GNSS time, or UTC time), time reference uncertainty information, and position information (e.g. pertaining to a position of UE 100) to modify or update the receive time reference uncertainty information to account for other inaccuracies and/or processing delays. For example, APs 240 may modify time reference uncertainty to adjust for inaccuracies, processing delays and/or SIFS delays, if appropriate. In some embodiments, the absolute time and time reference uncertainty information may be modified by AP 240 based on the distance of UE 100 from AP 240, which may be determined from the UE position fix.

In some embodiments, an AP 240 synchronized to an absolute timing reference may transmit the time reference information and timing uncertainty information to other STAs/devices. For example, the timing reference and timing uncertainty may be requested by and/or provided to one or more STAs that do not have access to the absolute timing reference source.

In some embodiments, APs 240 may use the absolute time reference (e.g. GNSS time) for measurements and/or time stamps. For example, packets or frames sent or received by APs 240 may be timestamped using the absolute time reference. In some embodiments, multiple APs 240 on network 230 may be synchronized to a common absolute time reference (e.g. to GNSS time) via timing information received from UEs 100 to obtain a quasi-synchronous network. In some embodiments, (e.g. in quasi-synchronized networks), AP 240 may estimate one way delay for packets received from another device/STA based on the timestamp indicating the time the packet was sent (TOD) by the other devices STA and time that the packet was received (ToA) at AP 240. In embodiments where one or more UEs 100 may also be synchronized to the absolute time reference (with some timing reference uncertainty), then, APs 240 that are also synchronized to the absolute time reference may estimate one way delay for packets (with the timing uncertainty) received from synchronized UEs 100 based on the ToD and ToA timestamps. Conversely, a UEs 100 may also estimate one-way delay for timestamped packets received from APs 240 that are synchronized to the common absolute time reference.

AP ranging engine 354 may negotiate and perform ranging operations with other wireless devices/STAs; create sounding sequences for transmission to other wireless devices/STAs, decode sounding sequences received from other wireless devices/STAs (such as to obtain RTT values, AoA information, and AoD information. In some aspects, the AP ranging engine 354 may capture or record timestamps of signals received by the AP 240 (such as TOA information) and timestamps of signals transmitted from the AP 240 (such as TOD information), and estimate angle information of frames exchanged with other wireless devices/STAs (such as AoA information and/or AoD information), AP positioning engine 356 may facilitate determination of the location of the AP 240 and/or facilitate location determination of one or more other wireless devices and may share location information of AP 240 with other wireless devices. In some embodiments, AP positioning engine may use information obtained during frame exchange and ranging operations (e.g. by AP frame exchange engine 252 and ranging engine 354) to determine the position of AP 240 and/or to facilitate position determination by another wireless device. In some embodiments, AP positioning engine 356 may share location information of the AP 240 and possibly the location of other APs in the vicinity with other wireless devices.

AP scheduling engine 358 may negotiate, establish, and announce passive ranging schedules to a number of other wireless devices/STAs. In some instances, the ranging schedules may be used by STAs to passively determine their respective locations (e.g. in instances when STA-AP positioning is unavailable and/or when the determined AP load/network load/channel load exceeds some threshold).

In some embodiments, an AP 240 may determine its availability for positioning at a first time and may transmit, based on the determination, information indicative of the AP's availability for positioning. The information indicative of the AP's availability for positioning may comprise at least one of: AP availability for STA-AP location determination, or STA-AP location determination capability, or whether AP-AP positioning is being performed; or the next scheduled passive AP-AP ranging session; or some combination thereof.

In some embodiments, the availability of AP 240 for positioning at a first time may be determined based on AP load or network load or channel load. In some embodiments disclosed herein, AP 240 may signal network load or AP load or channel load: (i) using fields in management frames; (ii) by signaling availability or non-availability to service STA-AP positioning requests (e.g. based on a determined or expected AP load/network load/channel load); (iii) signaling or temporarily altering capability for STA-AP positioning (e.g. when AP load/network load does not exceed a threshold); and/or (iv) some combination of the above. In some embodiments, AP 240 may further signal a capability for AP-AP positioning, and/or that AP-AP positioning is currently being performed, and/or announce ranging schedules.

In some embodiments, AP 240 may transmit a BSS Load element and/or other fields, which may include information such as values of parameters indicative of AP load. In some embodiments, when AP load exceeds some threshold, AP 240 may transmit information in a field (e.g. OE/IE/data) indicating suspension or temporary disabling of STA-AP positioning. For example, when load exceeds the threshold, AP 240 may transmit (e.g. broadcast) information indicating non-availability of AP 240 for STA-AP location determination at the current time or until some specified time. Further, AP 240 may transmit an indication that AP-AP location determination is being performed at the current time (or announce a ranging schedule), so that UEs 100 may listen to the AP-AP positioning session to determine their respective locations. In some embodiments, when the AP load does not exceed the threshold, AP 240 may transmit e.g. broadcast) information indicating availability of AP 240 for STA-AP location determination at the current time.

In some embodiments, AP 240 may determine or estimate network load/AP load based on one or more of: (a) a number or count of STAs/devices connected or communicatively coupled to the AP; (b) historical network usage (e.g. time of day, stored usage patterns, etc.), and/or AP utilization patterns; (c) available AP and/or network bandwidth; (d) current or expected AP/network bandwidth utilization; (e) a measure of network congestion; (f) channel load or channel utilization (e.g. number of devices using a particular channel or traffic on particular channel associated with the AP; and/or (g) some combination thereof. In instances, when AP 240 disables STA-AP positioning or indicates non-availability for STA-AP positioning based on historical network load/usage and or AP utilization patterns, AP 240 may provide an indication of a time or expected time when support for STA-AP positioning may be resumed.

Memory 330 may be implemented within processor(s) 350 or external to processor(s) 350. Memory 330 may include, for example, a primary memory and/or secondary memory. Primary memory may include, for example, a random access memory, read only, memory, etc. While illustrated in this example as being separate from processor(s) 350, it should be understood that all or part of a primary memory may be provided within or otherwise co-located/coupled with processor(s) 350. If implemented in firmware and/or software, the functions may be stored as one or more instructions or program code on a computer-readable medium, such as medium 378 and/or secondary memory. Examples include computer-readable media encoded with computer programs and data associated with or used by the program.

In certain implementations, secondary memory may be operatively receptive of, or otherwise configurable to couple to a computer-readable medium 378. As such, in certain example implementations, the methods and/or apparatuses presented herein may take the form in whole or part of a removable media drive 370 that may include computer-readable medium 378 with computer implementable instructions stored thereon, which if executed by processor(s) 350 may be operatively enabled to portions of the example operations including message flows and protocols described herein.

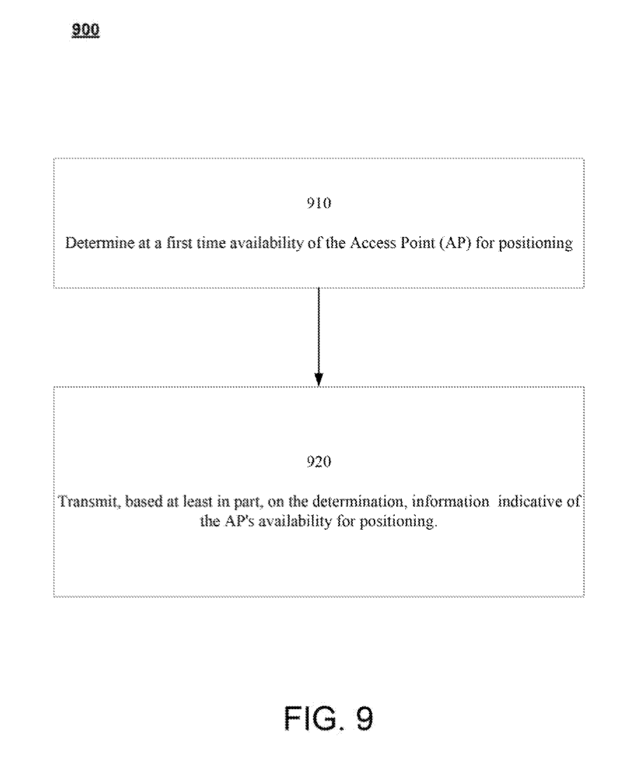

In some embodiments, computer-readable media 378 may include instructions for execution by the processor comprising instructions to perform any of the functionality described with reference to FIG. 9 and elsewhere in the specification. By of example, and not limitation, such computer-readable media can comprise one or of the following: RAM, ROM, PROM, EEPROM, NVRAM, flash memory, CD-ROM, or other optical disk storage, magnetic disk storage or other magnetic storage devices, or any other medium that can be used to store desired program code in the form of instructions and/or data and that can be accessed by a computer.

Any machine-readable medium tangibly embodying instructions may be used in implementing the methodologies described herein. For example, software may be stored using removable media drive 370, which may support the use of computer-readable media 378, including removable media. Program code may be resident on computer-readable media 378 and/or memory 330 and may be read and executed by processor(s) 350. For example, the computer-readable medium 378 including program code stored thereon may include program code to support wireless communication (including unicast, multicast, and broadcast), and/or sounding, ranging, positioning, and wireless medium characterization (including in a MIMO/MU-MIMO) environment in accordance with certain embodiments presented herein.

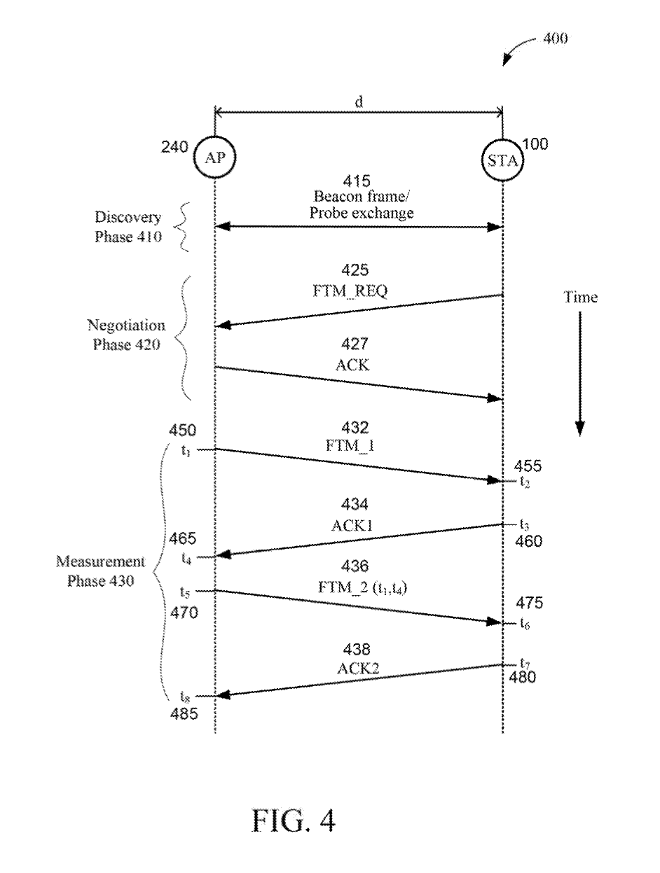

FIG. 4 is a diagram illustrating message flow for an example ranging operation 400. In some embodiments, example ranging operation 400 may be performed between a wireless station (STA) and an access point (AP) using Fine Timing Measurement (FTM) frames in accordance with the IEEE 802.11 REVmc standards. In some embodiments, ranging operation 400 may form part of an STA-AP ranging or location determination session.

As shown in FIG. 4, STA 100 (e.g. UE 100) may initiate or request a ranging operation with AP 240, which may respond to the ranging request. In general, any suitable wireless device/STA may be an initiator, and any suitable wireless device/STA (e.g. UE 100 or another AP 240) may be the responder. In some embodiments, ranging operation 400 may include discovery phase 410, negotiation phase 420, and measurement phase 430.

In some embodiments, during discovery phase 410, STA 100 may discover other wireless devices, within range of STA 100, that support ranging operations. In some implementations, STA 100 may discover AP 240 in an active manner, for example, by transmitting a probe request to AP 240. AP 240 may respond by transmitting a probe response, which may include an indication of availability and/or an indication of capability of AP 240 for positioning operations. For example, the indication of availability, which, in some instances, may be comprised in an AP capabilities message, may indicate whether AP 240 is available for and/or supports positioning operations. For example, AP capabilities message may indicate whether AP 240 is supports FTM ranging operations and/or STA-AP location determination/ranging and/or is available for STA-AP location determination/ranging operations. In some embodiments, STA 100 may discover AP 240 in a passive manner, for example, by receiving a management frame, shown in FIG. 4 as beacon frame 415, from AP 240.

In some embodiments, beacon frame 415 may indicate one or more of: (a) AP support for STA-AP location determination/ranging and/or b) whether AP 240 is currently available for performing STA-AP location determination/ranging operations. In some embodiments, AP may indicate one or more of (a)-(b) above based on a current or expected AP load or network load. For example, an affirmative indication of AP support for STA-AP ranging/location determination operations, and/or (b) an affirmative indication of AP availability for performing STA-AP ranging/location determination may be provided when AP load is low or does not exceed some threshold. Conversely, a lack of AP support for (or a negative indication of) STA-AP ranging/location determination operations, and/or (b) AP unavailability (or a negative indication of AP availability) for STA-AP ranging/location determination may be provided when AP load is high or exceeds the threshold. In some embodiments, AP 240 may also indicate: (c) whether AP 240 supports AP-AP ranging/location determination; and/or (d) whether AP is currently performing AP-AP ranging operations and/or whether AP-AP ranging operations have been scheduled. In some embodiments, AP 240 may convey of one or more of (a)-(e) above in one or more fields such as an extended capabilities OE, or a reserved bit in an existing capabilities OE, or through a vendor-specific information element (VSIE), or in any other suitable field, or IE/OE/data field of the a management frame, such as beacon frame 415. In some embodiments, beacon frame 415 may further indicate AP support for FTM ranging operations.

In some embodiments, AP 240 may transmit parameters related to a current AP load in a management frame. For example, AP 240 may transmit parameter related to a current AP load in a Basic Service Set (BSS) Load Element or Quality of Service (Qos) Basic Service Set (QBSS) Load Element field, which form part of beacon frame 415 (and/or a probe response frame). For example, the load element field may include information pertaining to one or more of: a number of STAs connected or communicatively coupled to the AP; or channel utilization for a communication channel between the STA and AP; channel load for a communication channel between the STA and AP; or an available admission capacity of the AP; a current available AP bandwidth; a current AP bandwidth utilization; AP load; a measure of network congestion; network load; and/or some combination thereof.

In some embodiments, UE 100 may use the information in beacon frame 415 to determine channel load/AP load/network load (e.g. explicitly based on parameters in a beacon frame and/or implicitly based on the APs indication of availability/support/capabilities for positioning). Further, in some embodiments, UE 100 may determine (e.g. based on implicitly based on the APs indication of availability/support/capabilities for positioning, and/or based on the AP load) whether to: (i) initiate STA-AP ranging/location determination; or (ii) passively determine its location by listening to an AP-AP ranging/location determination session or STA-AP ranging/location determination session for other STAs (e.g. when supported and available). For example, UE 100 may determine to request and use STA-AP positioning, when information in received beacon (or probe response) frame 415 indicates that: (i) the AP is available to perform STA-AP positioning; and/or (ii) the AP supports STA-AP positioning; and/or (iii) parameters (e.g. in the load element) indicate that AP load does not exceed some threshold. Conversely, UE 100 may determine to use AP-AP positioning, when information in received beacon frame 415 (or a probe response frame) indicates that: (i) the AP is currently performing AP-AP positioning or STA-AP positioning for other UEs: and/or (ii) AP-AP positioning and/or STA-AP positioning for other UEs has been scheduled within some time window of the current time; and/or (iii) when the AP indicates its non-availability for STA-AP positioning; and/or (iv) when the AP indicates a lack of support STA-AP positioning (e.g. at the current time); and/or (v) parameters (e.g. in the load element) indicate that current AP load exceeds some threshold.

During negotiation phase 420, STA 100 and AP 240 may exchange information and negotiate a number of ranging parameters and capabilities such as, for example, a capability of capturing timestamping, a capability of estimating angle information, a frame format to be used for each exchanging ranging frames, a bandwidth with which to transmit ranging frames, a duration of the ranging operation, a periodicity of the ranging operation, the number of frame exchanges or “bursts” for each ranging operation, timing information, and so on.

In some embodiments, during negotiation phase 420, UE 100 may transmit an absolute time reference (e.g. a GNSS time), a time reference uncertainty to AP 240 and a position fix (e.g. a GNSS position fix). In some embodiments, the GNSS time may be obtained (e.g. by UE 100) from a SPS resource such as one or more of: a Global Navigation Satellite System (GNSS) Real Time Clock (RTC) or GNSS system time (e.g. the UE may include and/or be coupled to an GNSS receiver, CDMA system time from LTE System Information Block 8 (SIB8) message; or GNSS system time from LTE System Information Block 16 (SIB16) message. In embodiments where the time reference and uncertainty information is transmitted during negotiation phase, the reference may be used for timestamping packets/frames during subsequent communications between AP 240 and UE 100. In some embodiments, the absolute time and time reference uncertainty information may be modified by APs 240 based on the distance of UE 100 from AP 240, which may be determined from the position fix.

In some embodiments, AP support for STA-AP ranging/positioning, AP-AP ranging/positioning, and/or information related to a current or scheduled AP performance of AP-AP positioning may also be transmitted to UE 100 in an AP capabilities field. AP capabilities information may further include information pertaining to AP support for FTM ranging operations. In some embodiments, the capability of AP 240 may be conveyed in one or more fields such as an extended capabilities IE, or a reserved bit in an existing capabilities IE, may be included in a vendor-specific information element (VSIE), or in any other suitable field or OE/IE/data field of a frame.

In some embodiments, STA 100 may initiate negotiation phase 420 by transmitting FTM request (FTM_REQ) frame 425 to AP 240. In addition to signaling or requesting the ranging operation 400, the FTM_REQ frame 425 may be used to request the number of ranging parameters and capabilities. AP 240 may receive FTM_REQ frame 425 and may acknowledge the requested ranging operation by transmitting an FTM acknowledgement (ACK) frame 427 to STA 100. In some embodiments, ACK frame 427 may be used to indicate the capabilities of AP 240 (as described above), and may accept a number of the ranging parameters requested by STA 100.

During the measurement phase 430, STA 100 and AP 240 may exchange a number of ranging or “measurement” frames. If both AP 240 and STA 100 support the FTM protocol, then the measurement phase 430 may be performed by exchanging a number of FTM frames. For example, at time 1 450, AP 240 may transmit FTM_1 frame 432 to STA 100, and may capture the TOD of the FTM_1 frame 432 as time t1 450. STA 100 may receive FTM_1 frame 432 at time t2 455, and may capture the TOA of the FTM_1 frame 432 as time t2 455. STA 100 may respond by transmitting a first acknowledgement (ACK1) frame 434 to AP 240 at time t3 460, and may capture the TOD of ACK1 frame 434 as time t3 460. AP 240 receives ACK1 frame 434 at time t4 465, and may capture the TOA of the ACK1 frame 434 as time t4 465. At time t5 470, AP 240 may transmit FTM_2 frame 436 that includes the timestamps captured at times t1 450 and t4 465 (such as the TOD of the FTM_1 frame 432 and the TOA of the ACK1 frame 434). STA 100 may receive the FTM_2 frame 436 at time t6 475, and may capture its timestamp as time t6 475.

Upon receiving the FTM_2 frame 436 at time t6 475, STA 100 has timestamp values for times t1 450, t2 455, t3 460, and t4 465 that correspond to the TOD of the FTM_1 frame 432 transmitted from AP 240, the TOA of the FTM_1 frame 432 at STA 100, the TOD of the ACK1 frame 434 transmitted from STA 100, and the TOA of the ACK1 frame 434 at AP 240, respectively. Thereafter, STA 100 may determine an RTT value as RTT=(t4−t3) (t2−t1). Because the value of RTT does not involve estimating the Short Inter-Frame Sequence interval (SIFS) for either STA 100 or AP 240, the value of RTT does not involve errors resulting from uncertainties in SIFS durations.

Accordingly, in some embodiments, based on the timestamp information and/or AoA/AoD information for frames exchanged with APs 240, UE 100 may be able to determine its position. In some embodiments, UE 100 may transmit an absolute time reference, a time reference uncertainty to APs 240 and the position fix during or following measurement phase. In embodiments where the time reference and uncertainty information is transmitted during/after measurement phase, the time reference may be used for timestamping packets/frames during subsequent communications between APs 240 and UE. 100. In some embodiments, the absolute time and time reference uncertainty information may be modified by APs 240 based on the distance of UE 100 from AP 240, which may be determined from the position fix. In some embodiments, after obtaining time reference related information, APs 240 may transmit the absolute time reference, time uncertainty information, and AP location information to one or more other UEs/STAs.

In some embodiments, multiple APs 240 on a network may be synchronized to a common absolute time reference (e.g. to GNSS time) via timing information received from UEs 100 to obtain a quasi-synchronous network. In some embodiments, (e.g. quasi-synchronized networks), APs 240 may estimate one way delay for packets received from another device based on the (absolute time reference based) timestamp indicating the time that the packet was sent (ToD) by a STA and time that the packet was received (ToA) at AP 240. In embodiments where one or more UEs 100 may also be synchronized to the absolute time reference (with some timing reference uncertainty), then, APs 240 that are also synchronized to the absolute time reference may estimate one way delay for packets (bounded by be timing uncertainty) received from synchronized UEs 100 based on the timestamp indicating the time the packet was sent and time that the packet was received at AP 240. Conversely, a UE 100 may also estimate one-way delay for packets received from APs 240 that are synchronized to the common absolute time reference.

In some embodiments, Wi-Fi ranging operations may be performed using frames transmitted as orthogonal frequency-division multiplexing (OFDM) symbols. The accuracy of RTT estimates may be proportional to the number of tones (such as the number of OFDM sub-carriers) used to transmit the ranging frames. For example, while a legacy frame may be transmitted on a 20 MHz-wide channel using 52 tones, a high-throughput (HT) frame or a very high-throughput (VHT) frame may be transmitted on a 20 MHz-wide channel using 56 tones, and a high-efficiency (HE) frame may be transmitted on a 20 MHz-wide channel using 242 tones. Thus, for a given frequency bandwidth or channel width, HT/VHT/HE frames use more tones than legacy frames, and may therefore provide more accurate channel estimates and RTT estimates than legacy frames.

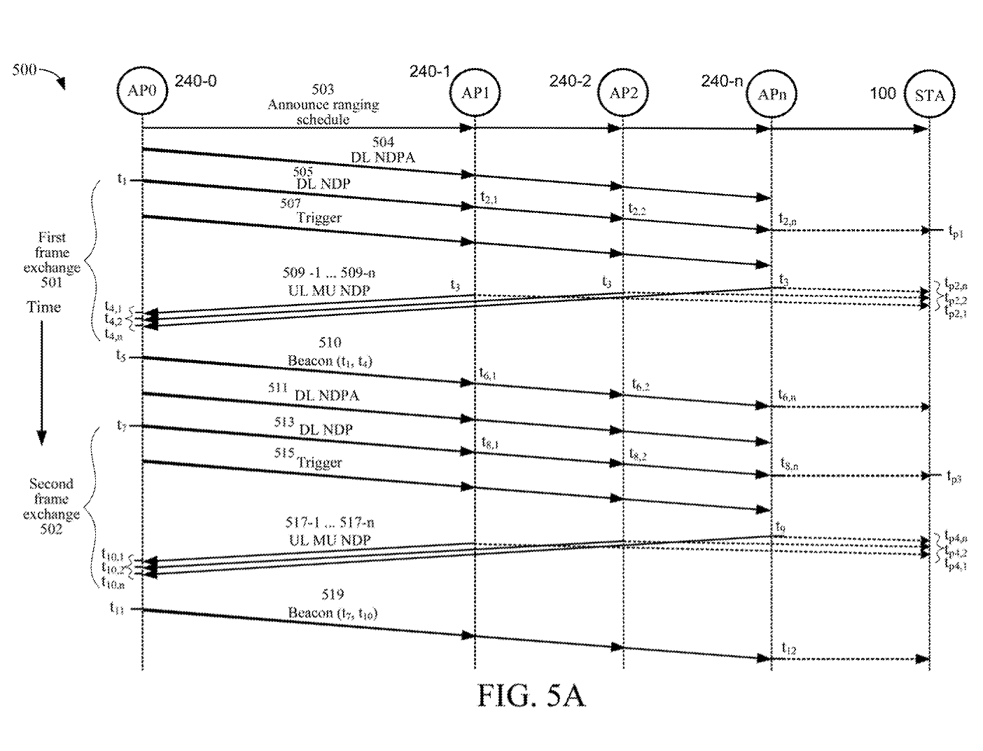

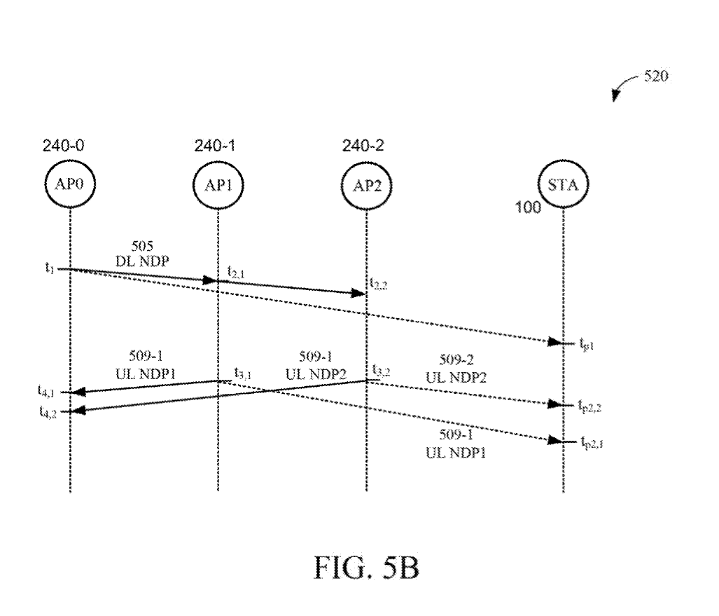

FIG. 5A shows a signal diagram of an example ranging operation 500, while FIG. 5B shows a signal diagram of a passive positioning operation 520 based on the ranging operation of FIG. 5A. Access points AP0 240-1-APn 240-n may be any suitable AP 240 or STA. In some embodiments, STA 100 may passively determine its location by listening to messages exchanged during AP-AP positioning sessions. In some embodiments, an STA 100-1 may passively determine its location by listening to messages exchanged during STA-AP positioning sessions for other STAs (e.g. by listening to messages exchanged between a subset of APs AP0 240-1-APn 240-n and STAs 100-j (j≠1)). STA 100 may be any suitable wireless device including, for example, UE 100. Although only one passive listening device (such as STA 100) is shown in FIGS. 5A and 5B, a WLAN may include a number of passive listening devices that may listen to frames exchanged in the ranging operation 500 to passively determine their locations simultaneously (e.g.) at the same time, or at substantially the same time, or within some short time interval).

In some embodiments, ranging operation 500 may be performed between a first access point (AP0) 240-0 operating as an initiator device and a number of other access points (AP1-APn) 240-1, 240-2 . . . 240-n operating as responder devices. For the example ranging operation 500, the access point AP0 240-0 is referred to as the initiator device based on its role in announcing the ranging schedule to the other access points AP1-APn, and the other access points AP1 240-1 . . . APn 240-n are referred to as responder devices based on their responding to the trigger frame transmitted by the access point AP0 240-0. STA 100 may listen to the frame exchanges between the initiator device AP0 240-0 and the responder devices AP1 240-1-APn 240-n, and passively determine its location.

In some embodiments, ranging operation 500 between APs 240 may be associated with or include a discovery phase, a negotiation phase, and a measurement phase. For example, during the discovery phase, the initiator device AP0 240-0 may discover other wireless devices that support ranging operations (such as the responder devices AP1 240-1-APn 240-n), and may indicate its ability to support features of the IEEE 802.11 (e.g. 802.11ax and/or 802.11az) specifications to the responder devices AP1 240-1-APn 240-n.

The capability to support the IEEE 802.11ax and IEEE 802.11az specification may be included in an extended capabilities IE field), may be a reserved bit in an existing capabilities IE, may be included in a vendor-specific information element (VSIE), or in any other suitable field of a management frame. In some aspects, the discovery phase of FIG. 5A may be similar to the discovery phase 410 of FIG. 4.

During the negotiation phase, the initiator device AP 240-0 may announce a ranging schedule 503 to the responder devices AP1 240-1-APn 240-n and to any nearby passive listening devices such as the STA 100. In some implementations, the initiator device AP0 240-0 may include the ranging schedule in beacon frames (along with its location and the location of other devices with which the device has ranging operation), which also may include the Timing Synchronization Function (TSF) value and the beacon interval of the initiator device AP0.

In some implementations, STA 100 may discover AP 240 in an active manner, for example, by transmitting a probe request to AP 240. AP 240 may respond by transmitting a probe response, which may include an indication of availability and/or an indication of capability of AP 240 for positioning operations. For example, the indication of availability, which, in some instances, may be comprised in an AP capabilities message, may indicate whether AP 240 is available for and/or supports positioning operations. For example, AP capabilities message may indicate whether AP 240 is supports FTM ranging operations and/or STA-AP location determination/ranging and/or is available for STA-AP location determination/ranging operations. In some embodiments, STA 100 may discover AP 240 in a passive manner, for example, by receiving a management frame, shown in FIG. 4 as beacon frame 415, from AP 240.

In some embodiments, beacon frame 415 may indicate AP availability for positioning operations. In some embodiments, the indication of availability for positioning operations may indicate: (a) whether AP 240 supports AP-AP ranging/location determination; and/or (b) whether AP is currently performing AP-AP ranging operations and/or (c) whether AP-AP ranging operations have been scheduled and/or (d) AP support for STA-AP location determination/ranging and/or (e) whether AP 240 is currently available for performing STA-AP location determination/ranging operations or some combination of (a)-(e) above. In some embodiments, AP 240 may convey of one or more of (a)-(e) above in one or more fields such as an extended capabilities OE, or a reserved bit in an existing capabilities OE, or through a vendor-specific information element (VSIE), or in any other suitable field, or IE/OE/data field of the a management frame, such as beacon frame 415. In some embodiments, beacon frame 415 may further indicate AP support for FTM ranging operations. In some embodiments, the initiator device AP0 240-0 may periodically embed the ranging schedule within management frames (such as within every M^{th} management frame, where M≥1, is an integer).

In some other implementations, the initiator device AP0 240-0 may include ranging schedule 503 in probe responses. In some aspects, the initiator device AP0 may include passive ranging schedule 503 in all probe responses. In some other aspects, the initiator device AP0 240-0 may include ranging schedule 503 in selected probe responses, for example, that are transmitted in response to probe requests that include a query or request for the passive ranging schedule.

In some implementations, ranging schedule 503 may include the following fields: a Scheduling field indicating the time of each ranging operation, the duration of each ranging operation, and an interval between ranging operations; a Participant field identifying which of the access points AP0 240-0-APn 240-n will participate in the scheduled ranging operations, and the role (such as either an initiator device or a responder device) each participating device plays; a Parameters field indicating a type of frames (e.g. null data packet announcement (NDPA), NDP, FTM, eFTM, etc.) to be used in the ranging operations, a number of antennas to be used by the participating initiator device AP0 or the responder devices AP1-APn, a frequency bandwidth to be used, a capability to capture timestamps (such as TOD and TOA values), and a capability to estimate angle information (such as AoD and AoA information); and a Location field indicating the location of the initiator device AP0 and the responder devices AP1-APn that will participate in the scheduled ranging operations.

The Scheduling field may indicate a time either before or after the transmission of a given management frame, such as a beacon frame, from the initiator device AP0 240-0 at which the ranging operation is to commence. In some aspects, the initiator device AP0 240-0 may schedule each frame exchange of ranging operation 500 to begin a time period prior to a corresponding target beacon transmission time (TBTT), for example, so that each frame exchange between the initiator device AP0 240-0 and the responder devices AP1 240-1-APn 240-n is completed prior to the transmission of a next beacon frame from the initiator device AP0 240-0. In this manner, frame exchanges associated with ranging operation 500 may not interfere with beacon frame transmissions from the initiator device AP0. Additionally, by completing a frame exchange with the responder devices AP1 240-1-APn 240-n prior to a given TBTT, the initiator device AP0 may include timing information (such as timestamps captured by the initiator device AP0) of the frame exchange into the next beacon frame.

The Participant field may identify participating wireless devices using association identity (AID) values of associated STAs, BSSID values of APs, MAC addresses, or any other suitable identifying information. In some aspects, the Participant field also may indicate whether each of the identified participant devices is an access point or a client device, and whether each of the identified participant devices is to operate as an initiator device or as a responder device.

The Parameters field may indicate any suitable type of frame to be exchanged between the initiator device AP0 240-0 and the responder devices AP1 240-1-APn 240-n. In some implementations, the initiator device AP0 240-0 and the responder devices AP1 240-1-APn 240-n may exchange null data packets (NDP) that contain a number of sounding sequences and multiple RTT values may be obtained from each frame exchange (e.g. as depicted in the example ranging operation 500 of FIG. 5A).

In some other implementations, ranging operation 500 may be performed by exchanging FTM or enhanced FTM frames (eFTM frames) between the initiator device AP0 240-0 and responder devices AP1 240-1-APn 240-n. As used herein, eFTM frames may refer to FTM frames that have been modified (relative to FTM frames, as defined in the IEEE 802.11REVmv standards) to include a number of additional sounding sequences. The additional sounding sequences may facilitate obtaining a corresponding number of additional RTT values from each frame exchange. In some aspects, the number of additional sounding sequences may be contained in a packet extension of an HE packet that encapsulates the FTM frame. The Parameters field also may indicate a frequency bandwidth to be used by the initiator device and the responder devices when transmitting frames during the ranging operation may indicate a capability to capture timestamps of transmitted frames, may indicate a capability to estimate TOA values of received frames, and may indicate a capability to estimate angle information of received frames.

The Location field may indicate the locations of the initiator device AP0 and the responder devices AP1-APn in any suitable manner. In some aspects, the locations may be specified as civic addresses (e.g. street addresses), geographic locations, or in geo-spatial coordinates (e.g. longitude, latitude, altitude), absolute coordinates, or in some other form.

In some other implementations, ranging schedule 503 may include a Channel field identifying one or more channels upon which the scheduled ranging operations are to be performed. The Channel field may identify a single channel or multiple channels to be used for ranging operations, and may indicate a frequency bandwidth of the identified channel(s). In some implementations, the initiator device AP0 240-0 may specify that ranging operations (such as ranging operation 500) will be performed on the channel used by its BSS, for example, so that STAs associated with the initiator device AP0 240-0 can listen on that channel. In some other implementations, the initiator device AP0 240-0 may specify that ranging operations (such as the ranging operation 500) will be performed on multiple channels. In these implementations, ranging schedule 503 also may indicate channel switching information that indicates specific times at which each of the responder devices AP1 240-1-APn 240-n and the passively listening devices (such as STA 100) are to switch wireless channels. In some aspects, the specified channel switching times may be based on (or referenced to) the TSF value of the initiator device AP0.

After the discovery and negotiation phases are complete, the initiator device AP0 240-0 may begin the measurement phase. For the example ranging operation 500, the initiator device AP0 240-0 may transmit a downlink (DL) NDPA 504 to the responder devices AP1 240-1-APn 240-n. DL NDPA 504 may announce that the initiator device AP0 240-0 is initiating first frame exchange 501, and inform the responder devices AP1 240-1-APn 240-n to listen for a subsequent DL Null Data Packet (NDP).

In FIG. 5A, at time t1, the initiator device AP0 240-0 transmits DL NDP 505 to the responder devices AP1 240-1-APn 240-n, and initiator device AP0 240-0 may capture the TOD of the DL NDP 505 as time t1. In some embodiments, transmission of NDPA 504 and the NDP 505 may be separated by a Short Interframe Spacing (SIFS) duration. DL NDP 505 may include a number of sounding sequences from which multiple RTT values may be obtained. The sounding sequences contained in DL NDP 505 may be high-efficiency long training fields (HE-LTFs), very high-throughput long training fields (VHT-LTFs), high-throughput long training fields (HT-LTFs), or legacy LTFs. In some aspects, the sounding sequences may be orthogonal to each other, for example, so that the responder devices AP1-APn can distinguish between sounding sequences transmitted from different antennas of the initiator device AP0.

In FIG. 5A, the responder devices AP1 240-1-APn 240-n may receive DL NDP 505 at times t2,1 through t2,n, respectively, and may capture the corresponding TOAs. Each of the responder devices AP1 240-1-APn 240-n may obtain separate TOA values from each of the sounding sequences contained in DL NDP 505. In some aspects, the responder devices AP1 240-1-APn 240-n may estimate channel conditions and derive angle information from the sounding sequences comprised in DL NDP 505.

In FIG. 5A, at time t3, the responder devices AP1 240-1-APn 240-n transmit corresponding Uplink (UL) MU NDPs 509-1-509-n to the initiator device AP0 240-0, and may capture the TOD of the UL MU NDPs 509-1-509-n as time t3. Each UL MU-NDP 509-1-509-n may include a number of sounding sequences from which multiple RTT values may be obtained (and from which channel conditions may be estimated). The sounding sequences contained in each of the UL MU-NDPs 509-1-509-n may be HE-LTFs, VHT-LTFs, HT-LTFs, or legacy LTFs. In some aspects, the sounding sequences may be orthogonal to each other, for example, so that the initiator device AP0 240-0 can distinguish between sounding sequences transmitted from different antennas of any one responding AP 240-i, i=1 . . . n.

In FIG. 5A, the initiator device AP0 240-0 receives UL MU-NDPs 509-1-509-n at times t4,1 through t4,n, respectively, and initiator device AP0 240-0 may record the corresponding TOAs of UL MU-NDPs 509-1-509-n. UL MU-NDPs 509-1-509-n, which may all be transmitted at time t3 from the responder devices AP1 240-1-APn 240-n, may arrive at the initiator device AP0 240-0 at different times, for example, because the distances between the initiator device AP0 240-0 and each responder device AP1 240-i, i=1 . . . may be different.

In FIG. 5A, at time t5, the initiator device AP0 transmits a first management frame, shown as beacon frame 510 in FIG. 5A, to the responder devices AP1-APn, for example, according to the TBTT schedule of the initiator device AP0. The first beacon frame 510, which is received by the responder devices AP1 240-1-APn 240-n at times t6,1 through t6,n respectively, may include timestamp values for t1 (which corresponds the TOD of the DL NDP) and t4,1 to t4,n (which correspond to the TOAs of the UL MU-NDPs received from the responder devices AP1 240-1-APn 240-n, respectively. The ability to transmit timestamp values for t1 and t4,1 to t4,n in a beacon frame (which is typically broadcast by the initiator device AP0 240-0 periodically—and conventionally, is unrelated to specific ranging operations) may obviate the need for a separate frame in the first exchange 501 to provide the timing information to the responder devices AP1 240-1-APn 240-n.

Thus, in FIG. 5A, upon reception of first beacon frame 510, each of the responder devices AP1 240-1-APn 240-n has timestamp values for t1, t2, t3, and t4,1 to t4,n, and may determine the RTT between itself and the initiator device AP0 using the expression RITTi=(t,4,i−t3)+(t2,i−t1). For example, first responder device AP1 240-1 can determine RTT values using the expression RTT=(t,41−t3)+(t2,1−t1), the second responder device AP2 240-2 can determine RTT values using the expression RTT2=(t4,2−t3)+(t2,2−t1), and the nth responder device APn 240-n can determine RTT values using the expression RTTn=(t4,n−t3)+(t2,n−t1).

Although not depicted in FIG. 5A, the first beacon frame also may contain or indicate angle information and location information. The angle information may include AoD information of the DL NDP transmitted from the initiator device AP0 240-0, AoA information of the UL MU-NDPs received by the initiator device AP0 240-0, or both. The location information may include the location of the initiator device AP0 240-0, the locations of one or more the responder devices AP1 240-1-APn 240-n, or any combination thereof. In some embodiments, following first frame exchange 501, a second frame exchange 502 may be commenced by transmission of second DL NDPA 511.

In some embodiments, as shown in FIG. 5A, as a passive listening device, STA 100 may receive all of the frames exchanged between the initiator device AP0 240-0 and the responder devices AP1 240-1-APn 240-n. For example, STA 100 may receive the first DL NDP 505 transmitted from the initiator device AP0 240-0 at time tp1, may receive UL MU NDPs 509-1-509-n transmitted from the responder devices AP1 240-1-APn 240-n at times tp2,1 to tp2,n, may receive the second DL NDP 513 transmitted from the initiator device AP0 240-0 at time tp3, and may receive the second UL MU NDPs 517-1 . . . 517-9 transmitted from the responder devices AP1 240-1-APn 240-n (e.g. in response to second Trigger frame 515) at times tp4,1 to tp4,n. In some embodiments, STA 100 may receive first beacon frame 510 transmitted from the initiator device AP0 and extract timestamps for time t1 and times t4,1 to t4,n, and also may receive the second beacon frame 519 transmitted from the initiator device AP0 240-0 and extract timestamps for time t7 and times t10,1 to t10,n.

In some embodiments, STA 100 may use the timestamps corresponding to different sets of times t1-t4 to passively determine its location (e.g. based on the differences in distance between STA 100 and each of the access points AP0 240-0-APn 240-n).

FIG. 5B shows an example message flow between STA 100 and AP0, 240-0, AP1 240-1, and AP2 240-2 where STA 100 estimates its position passively during a portion of the AP-AP positioning operation shown in FIG. 5A. In some embodiments, one or more STAs 100 may perform passive AP-AP positioning (e.g. using the example message flow shown in FIG. 5B) when an AP indicates: (i) unavailability for STA-AP positioning; and/or (ii) a lack of support for STA-AP positioning (e.g. at a current time or at some specified time); and/or (iii) performance of AP-AP positioning (e.g. at a current time or within some time window of the current time); and/or (iv) that AP load (e.g. as indicated by APs 240 or as determined by STAs 100 based on parameters transmitted by APs 240 in a management frame) exceeds some threshold. Referring to FIG. 5B, STA 100 may receive a first UL MU-NDP 509-1 from AP1 240-1 at time tp2,1 and may receive a second UL MU NDP 509-2 from AP2 240-2 at time tp2,2. STA 100 may receive the first DL NDP 505 transmitted from the initiator device AP0 240-0 at time tp1. Further, (as shown in FIG. 5A) STA 100 may receive UL MU NDP 517-1 . . . 517-n from APs 240-1 through 240-n at times t4_1 through t4_n, respectively (not shown in FIG. 5B). STA 100 may use the captured timestamps tp2,1, tp2,2, and tp1 and the timestamps for times t4,1 to t4,n and time t3 provided in one or more of the UL MU NDP 517-1 . . . 517-n response frames to calculate a number of differential distances between STA 100 and the access points AP0 240-0-AP2 240-2. For example, STA 100 may calculate the differential distance (D1) between itself and AP0 240-0 and AP1 240-1 using the expression:

D1=[tp1−(tp2,1−(t4,1−t1−ToF1))]*c,

where ToF1 (equal to one-half of the RTT (RTT1) between AP0 240-0 and AP1 240-1) is the time-of-flight between AP and AP1, and c is the speed of light. Similarly, the STA may calculate the differential distance (D2) between itself and AP0 240-0 and AP2 240-2 using the expression:

D2=[tp1−tp2,2−(t4,2t1+ToF2)]*c,

where ToF2=(1/2)*(RTT2) is the time-of-flight between AP0 240-0 and AP2 240-2, and c is the speed of light. Although not shown in FIG. 5B, STA 100 may calculate the differential distance between itself and AP0 240-1 and one or more APi 240-i, i=3 . . . n in a similar manner and then use well-known hyperbolic navigation techniques (e.g. multi-lateration) to determine its location. Because the STA does not transmit any frames (but rather listens to the NDPs exchanged between the access points AP0-APn), the STA may determine its location passively, use less power (when compared to active ranging operations), and avoid revealing its own location.

In some embodiments, initiator device AP0 240-0 may perform ranging operations with the responder devices AP1 240-1-APn 240-n using an FTM protocol (e.g. using FTM/eFTM frames instead of exchanging NDPs as depicted in the ranging operation 500 of FIG. 5A).

In some embodiments, after announcing the passive ranging schedule, initiator device AP0 240-0 may initiate the measurement phase by transmitting trigger frame 507, which may: (a) inform each of the responder devices AP1 240-1-APn 240-n that the ranging operation has been initiated; (b) solicit UL MU-NDPs from responder devices AP1 240-1-APn 240-n to the initiator device AP0 240-0; and (c) serve as an implicit NDPA for DL NDPs to be transmitted from the initiator device AP0 240-0, following reception of UL MU-NDPs from responder devices AP1 240-1-APn 240-n (solicited in (b) above). Upon transmission of the corresponding times of arrival of the UL MU-NDPs from responder devices AP1 240-1-APn 240-n, and the time of departure of the DL NDP frame, responder devices may have adequate information to determine RTT. Further, as a passive listening device, the STA may receive all of the frames exchanged between the initiator device AP0 and the responder devices AP1 240-1-APn 240-n and record times of arrival of the frames. In addition, STA 100 may also receive and extract timestamp information in one or more frames exchanged between AP0 240-0 and APs 240-1-240-n. As outlined above, the STA 100 may use the recorded frame arrival times and extracted timestamp information to passively determine its location based on the differences in distance between the STA and each of the access points AP0-APn.

As another example, after announcing the passive ranging schedule, ranging operation may be performed using single-user (SU) frames transmitted according to the FTM protocol. For example, each of access points AP1 240-1-APn 240-n may request a ranging operation. Thus, the access points AP1 240-1-APn 240-n are initiators and access point AP0 240-0 is the responder. Initiators AP1 240-1-APn 240-n may initiate the negotiation phase by transmitting FTM_REQ frames to responder AP0 240-0. FTM_REQ frames may request the number of ranging parameters and capabilities, and responder AP0 240-0 may respond with an ACK frame, which may indicate the capabilities of AP0 and may accept a number of the requested ranging parameters.

Further, during a measurement phase, the initiator devices AP1 240-1-APn 240-n and the responder device AP0 240-0 may exchange a number of FTM frames (when the devices support the FTM protocol). Based on the recorded and extracted times of arrival and times of departure of the FTM and acknowledgement frames, initiator devices AP1 240-1-APn 240-n may have adequate information to determine RTT. Further, as a passive listening device, the STA may receive all of the frames exchanged between the responder device AP0 and the initiator devices AP1 240-1-APn 240-n and record times of arrival of the frames. In addition, STA 100 may also receive and extract timestamp information in one or more frames exchanged between AP0 240-0 and APs 240-1-240-n. As outlined above, the STA 100 may use the recorded frame arrival times and extracted timestamp information to passively determine its location based on the differences in distance between the STA and each of the access points AP0-APn.

Thus, ranging operation 500 described above in FIG. 5A and FIG. 5B are merely exemplary. In general, STA 100 may use passive listening to determine its location with various other types of AP-AP ranging operations. FIG. 5A and FIG. 5B are merely examples to illustrate passive UE position determination based on AP-AP positioning. However, the techniques used may be applied to various other AP-AP ranging/positioning schemes.

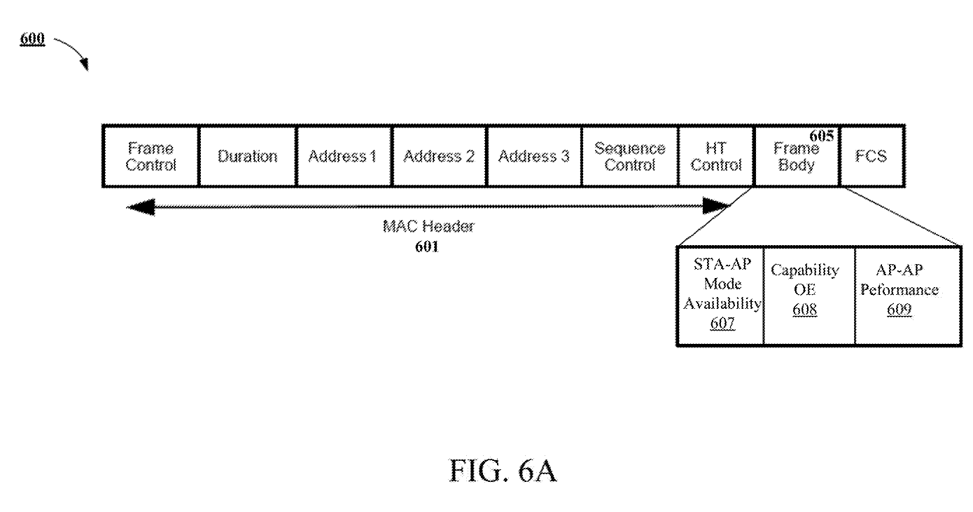

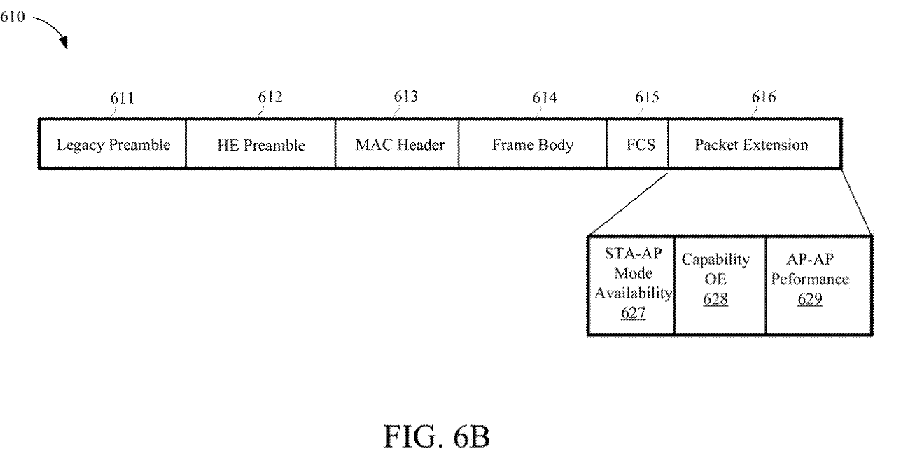

FIG. 6A shows management frame 600. In some implementations, the management frame 600 may be used for beacon frames such as those shown in the ranging operation 500 described above. In some other implementations, management frame 600 may be used for probe responses, which may contain one or more of: passive ranging schedules; STA capability information; AP load/network load information; information pertaining to positioning mode availability, support, and/or performance; and/or other information in accordance with various aspects of the present disclosure.

In some embodiments, management frame 600 may include a MAC header 601, a frame body 605, and a frame check sequence (FCS field. MAC header 601 may include: information about the type of frame (e.g. to identify the frame as a management frame), a frame control field, source and destination addresses, sequence control, and HT control. The frame control field may include control information specifying the type of frame, which may be used to process subsequent fields in management frame 600. The duration field may indicate the remaining duration for transmission of the next frame. The sequence control field indicates the sequence number of each frame. The HT control field indicates whether the frame is an HT or VHT frame. FCS field includes error detection information.

In some embodiments (e.g. when used as a beacon frame), in management frame 600, the “Address 1” field may store a broadcast address value, the “address 2” field may contain the MAC address of the broadcasting AP (e.g. AP0 240-0 in FIG. 5A), and the “address 3” field may contain the BSSID of the corresponding WLAN (e.g. associated with AP0 240-0).

In some embodiments, frame body 605 of management (beacon) frame 600 may include an indication of AP day for positioning operations. In some embodiments, frame body 605 of management (beacon) frame 600 may include one or more of: STA-AP mode availability field 607, AP capability field 608, and/or AP-AP performance field 609. In some embodiments, the values of one or more bits in one or more of STA-AP mode availability field 607 and/or AP capability field 608 may be changed based on AP load and may provide an indication of AP load.

In some embodiments STA-AP mode availability field 607 may indicate that STA-AP positioning is currently available to requesting STAs. In some embodiments, AP capability field 608 may indicate AP support for STA-AP positioning and/or AP-AP positioning and/or another positioning mode. In some embodiments, one or more bits in AP-AP performance field 609 may also indicate availability for AP-AP positioning, and/or indicate whether AP-AP positioning is being performed, and/or indicate schedule for the next AP-AP ranging/positioning session.

For example, if a single bit is used to indicate AP availability for AP-AP positioning or STA-AP positioning, then the single bit may be toggled to indicate the currently available AP positioning mode (e.g. STA-AP positioning or AP-AP positioning). As a further example, if a plurality of bits are used, each bit or some combination of bits may be used to indicate a specific AP condition such as, for example, one or more of: current support for STA-AP positioning; STA-AP positioning availability; support for AP-AP positioning, AP-AP positioning availability, and/or current performance of AP-AP positioning, a schedule for AP-AP positioning, or some combination thereof, etc. Accordingly, the number of bits used may depend on the information being conveyed by the AP such as the number of positioning modes supported and availability /performance of those positioning modes under various network load/AP load conditions.

As another example, AP-AP performance field 609 may indicate support for AP-AP positioning and/or whether AP-AP positioning is currently being performed and/or may indicate a time (e.g. relative to the current time or relative to another event) or schedule for the next AP-AP positioning session. For example, a Scheduling field, in management frame 600 (e.g. a beacon frame), may indicate a time either before or after the transmission of a given management frame, such as a beacon frame, from the initiator device AP0 240-0 at which a ranging operation is to commence.

In some embodiments, based on AP load, one or more bits in STA-AP mode availability field 607 and/or AP capability field 608 may be changed. For example, when AP load is high, one or more bits in STA-AP mode availability field 607 may set to indicate that STA-AP positioning is unavailable. As another example, when AP load is high, one or more bits in AP capability field 608 may set to indicate that STA-AP positioning is not supported. Conversely, when AP load is low, one or more bits in STA-AP mode availability field 607 may set to indicate that STA-AP positioning is available. As another example, when AP load is low, one or more bits in AP capability field 608 may set to indicate that STA-AP positioning is supported. Thus, STA-AP mode availability field 607 and/or AP capability field 608 may be viewed as indicators of AP load.

In some embodiments, AP load may also be indicated in a Load Element field that may be comprised in management frame 600. For example, the Load Element or extended Load Element field may provide values of parameters related to AP load including one or more of: a number of STAs connected or communicatively coupled to the AP; or information pertaining to channel utilization for a communication channel between the STA and AP; or an available admission capacity; channel load for a communication channel between the STA and AP, a current available AP bandwidth; a current AP bandwidth utilization; a measure of network congestion; and/or some combination thereof.

In some embodiments, STA 100 desiring position determination may use information received in management frame 600 to determine whether to initiate STA-AP positioning or passively determine its location. In some embodiments, STA 100 may obtain an indication of an AP load; and may initiate, based on the indication of the AP load, either STA-AP location determination, or perform passive location determination to determine a location of STA 100. For example, STA-AP mode availability field 607 and/or AP capability field 608 may be used as implicit indicators of AP load. Accordingly, STA 100 may use passive positioning to determine its position, when bits in STA-AP mode availability field 607 indicate that STA-AP positioning is unavailable; or, may use STA-AP positioning to determine its position, when bits in STA-AP mode availability field 607 indicate that STA-AP positioning is available. Similarly, STA 100 may use passive positioning to determine its position, when bits in AP capability field 608 indicate that STA-AP positioning is not supported; or, may use STA-AP positioning to determine its position, when bits in AP capability field 608 indicate that STA-AP positioning is supported. As another example, based on parameters in the Load Element field, the STA may determine an AP load, and may initiate STA-AP location determination when the AP load does not exceed a threshold; or may perform passive location determination is initiated when the AP load exceeds the threshold.

In some embodiments, the STA 100 may determine, based on AP-AP performance field 609 and other fields (e.g. scheduling field) in received management frame 600, whether passive AP-AP ranging/positioning is scheduled to occur within some time period of the current time, and, if the determination is affirmative, may elect to use AP-AP positioning. Accordingly, if AP-AP ranging/positioning is supported and/or is scheduled to be performed within some time period of the current time, STA 100 may opt to passively determine its location by listening to message exchanges between APs 240. In some instances (e.g. when AP-AP performance field 609 indicates that AP-AP positioning is not scheduled to be performed within some time period of the current time), then, STA 100 may initiate, based on the indication of the AP load, either STA-AP location determination, or AP-AP location determination to determine a location of STA 100. For example, if the AP indicates current support for STA-AP positioning (e.g. based on information in AP capability field 608), or that STA-AP positioning is currently available (e.g. based on information in STA-AP mode availability field 607), or the STA determined AP workload is below some threshold, then the STA may request STA-AP positioning. Otherwise, STA 100 may determine its position using passive AP-AP positioning.

FIG. 6B shows an example high efficiency (HE) frame 610. The HE frame 610 may be used to transmit one or more of the frames exchanged during the ranging operations 500 described above. The HE frame 610 is shown to include a legacy preamble 611, a HE preamble 612, a MAC header 613, a frame body 614, a frame check sequence (FCS) field 615, and a packet extension 616. The legacy preamble 611 may include synchronization information, timing information, frequency offset correction information, and signaling information. The HE preamble 612 also may include synchronization information, timing information, frequency offset correction information, and signaling information.

The MAC header 613 may contain information describing characteristics or attributes of data encapsulated within the frame body 614, may include a number of fields indicating source and destination addresses of the data encapsulated within the frame body 614, and may include a number of fields containing control information. More specifically, the MAC header 613 may include, for example, frame control field, a duration field, a destination address field, a source address field, a BSSID field, and a sequence control field.

The frame body 614 may store data including, for example, one or more IEs or OEs that may be specific to the frame type indicated in the MAC header 613. The FCS field 615 may include information used for error detection and data recovery.

Typically, packet extension 616 (which, in some implementations, may take the form of an OE field) may not store functional data, but rather stores “dummy” data or padding, for example, to allow a receiving device more time to decode HE frame 610 without giving up medium access.

In some aspects, the packet extension 616 may be used for STA-AP mode availability field 627, AP capability field 628, and/or AP-AP performance field 629. In some embodiments, STA-AP mode availability field 627, AP capability field 628, and/or AP-AP performance field 629 may provide an indication of AP load in a manner similar to STA-AP mode availability field 607, AP capability field 608, and AP-AP performance field 609, respectively. For example, as outlined above, AP capability field 628 may indicate AP support for STA-AP positioning, while AP-AP performance field 609 may indicate AP availability for AP-AP positioning, and/or indicate whether AP-AP positioning is being performed, and/or provide a schedule/time for the next AP-AP ranging/positioning session. In some embodiments, based on AP load, one or more bits in STA-AP mode availability field 627 and/or AP capability field 628 may be changed. For example, when AP load is high, one or more bits in STA-AP mode availability field 627 may set to indicate that STA-AP positioning is unavailable. As another example, when AP load is high, one or more bits in AP capability field 628 may set to indicate that STA-AP positioning is not supported.

In some embodiments, STA 100 desiring position determination may use information provided in HE frame 610 may opt to passively determine its location by listening to message exchanges between APs 240 when AP-AP positioning is available and is currently being performed, or is scheduled to be performed within some time window of the current time (e.g. using information in AP-AP performance field 629 in HE frame 610).

In some instances (e.g. when AP-AP performance field 629 in HE frame 610 indicates that AP-AP positioning is not being performed), then, if the AP supports or is available for STA-AP positioning (e.g. based on information in AP capability field 628 or information in STA-AP mode availability field 627, STA 100 may request STA-AP positioning.

In some embodiments, STA 100 may use the Load Element OE (not shown in FIGS. 6A and 6B) to determine whether to request STA-AP positioning. Based on the Load Element OE, STA 100 may determine if the load on an associated AP 240 exceed some threshold. If the load does not exceed the threshold, and the AP supports STA-AP positioning, then STA 100 may request STA-AP positioning if STA-AP positioning is currently available (e.g. based on information in STA-AP mode availability field 607, which may be an OE field, in Management frame 600 or HE frame 610). On the other hand, if the load exceeds the threshold, then, if the AP supports STA-AP positioning (e.g. based on information in the load element OE), then, STA 100 may opt to listen to AP-AP location determination sessions to determine its location (when AP-AP location determination is available and is currently being performed).

FIG. 7 shows an example flowchart for a method 700 to facilitate UE location determination. In some embodiments, method 700 may be performed on a STA such as UE 100 (e.g. by processor(s) 150). In some embodiments, UE 100 may receive one or more management frames 600 and/or HE frame 610 from an AP 240 and method 700 may be performed, based, in part, on the information in management frames 600 and/or HE frame 610. For example, management frames 600 and/or HE frame 610 may include indications of availability for positioning for one or more Access Points (APs) communicatively coupled to the STA. Each indication of availability may correspond to a distinct AP of the one or more APs. The indications of availability may comprise: AP-AP performance field 609 or AP-AP performance field 629 or a Scheduling field, indicating a scheduled time for an AP-AP ranging/position session. In some embodiments, management frame 600 may further include one or more of: (i) a Load Element/extended Load Element; (b) STA-AP mode availability field 607 or STA-AP mode availability field 627; (c) AP capability field 608 or AP capability field 628. In some embodiments, Load Element/extended Load Element may be specified in a Basic Service Set (BSS) Load Element, or a Quality of Service QoS) Basic Service Set (QBSS) Load Element.

In block 710, UE 100 may determine if AP-AP positioning is being performed with a time window of the current time t—e.g. between t and (t+Δt). In some embodiments, UE 100 may determine a schedule for AP-AP positioning based on information in management frames 600 and/or HE frame 610. For example, may UE 100 may determine a schedule for passive positioning based on information in one or more of AP-AP performance field 609, AP-AP performance field 629, and/or a Scheduling field, which may indicate a scheduled time for an AP-AP ranging/position session. In some embodiments, UE 100 may infer that an AP-AP positioning session or an STA-AP positioning session may be starting or in progress based on timing messages exchanged between two or more APs and/or between one or more APs and other STAs.

If AP-AP positioning is being/to be performed with a time window of the current time (“Y” in block 710), then, in block 715, UE 10 may perform passive positioning. For example, when AP-AP ranging /positioning is being performed with some time window that is acceptable for UE positioning performance (e.g. based on when the position is desired, UE configuration, user settings, system performance standards, etc.), then network bandwidth, battery resources on the UE, AP load, etc. may be reduced when the UE opts to use AP-AP positioning. In some embodiments, a UE may opt to use passive positioning to determine its position based on one or more of: a current battery level and/or to avoid revealing its position to other devices in addition to considerations related to network load, AP-load and/or channel load.

In some embodiments, a UE may (e.g. without regard to network load/AP-load/channel load) use passive positioning to determine its position based on one or more of: (a) a current battery level, (b) to conserve power (e.g. based on a current power mode setting), (c) to avoid revealing its position to other devices (d) to avoid charges for location determination, where a network provider limits STA-AP positioning to paying subscribers, (e) to determine its location, where a network provider limits STA-AP positioning to authorized subscribers/devices. In situations such as (a)-(e) above, the UE may skip block 710 proceed directly to block 715 to determine its position based on passive positioning.

Referring to FIG. 7, in block 710, if AP-AP positioning is not being performed within a time window of the current time (“N” in block 710), then, in block 720, UE 100 may determine, based on desired STA position dimensionality (e.g. 1D, 2D, or 3D) and indications of AP availability, whether the number of distinct APs in a subset of APs available for STA-AP positioning is sufficient to determine the position of UE 100 with the desired dimensionality. In some embodiments, UE 100 may obtain an indication of AP availability for STA-AP positioning based on information in management frame 600 such as STA-AP mode availability field 607 or STA-AP mode availability field 627; and/or AP capability field 608 or AP capability field 628.

In some embodiments, RSSI levels of APs may be used, at least in part, to determine, screen, or filter the subset of APs available for STA-AP positioning. For example, UE 100 may exclude APs with RSSI levels below some threshold (which may indicate larger distance from UE 100 or poor signal quality) from consideration, when determining the subset of APs available for STA-AP positioning.

In some embodiments, UE 100 may alternatively or additionally, determine, screen, or filter the subset of APs available for STA-AP positioning based on AP load and/or channel load. For example, UE 100 may exclude APs with AP/channel load above some threshold from consideration, when determining the subset of APs available for STA-AP positioning. In some embodiments, UE 100 may obtain information of AP load/channel load based on information in management frames 600 and/or HE frame 610 based on values of parameters related to AP load, in a Load Element or extended Load Element field.

In some embodiments, some function of the parameters related to AP load, in a Load Element or extended Load Element field may be used to determine the AP load. For example, the Load Element or extended Load Element field may include one or more of: a number or count of STAs/devices connected or communicatively coupled to the AP; or information pertaining to channel utilization or a channel load for a communication channel between the STA and AP; or an available admission capacity; or a current available AP bandwidth; or a current AP bandwidth utilization. In some embodiments, a measure of network congestion may be used to estimate AP load or obtain an indication of AP load. In some embodiments, a function based on one or more of the above parameters may be used to calculate AP load. As one example, if the number of STAs/devices communicatively coupled to the AP exceeds some specified number, then, UE 100 may infer that AP load is high, whereas, if the number of STAs/devices connected to the AP does not exceed the specified number, then, UE 100 may infer that AP load is low.

In block 725, UE may determine whether to use STA-AP positioning or AP-AP positioning based, in part, on whether the subset of AP (e.g. determined in block 720) includes an adequate number of APs to perform STA-AP positioning in order to determine its position with the desired position dimensionality.

If the subset of AP (e.g. determined in block 720) does not include an adequate number of APs to perform STA-AP positioning to determine the position of UE 100 with the desired position dimensionality (“N” in block 725), then, in some embodiments, in block 730, UE 100 may determine its position based on passive positioning (e.g. as outlined above in relation to FIGS. 5A and 5B).

If the subset of AP (e.g. determined in block 720) includes an adequate number of APs to perform STA-AP positioning to determine the position of UE 100 with the desired position dimensionality “Y” in block 725), then, in some embodiments, in block 740, UE 100 may determine its position based on STA-AP positioning (e.g. as outlined above in relation to FIG. 4).

In some embodiments, in block 740, it may be determined if STA-AP location determination in block 735 was successful. For example, success of STA-AP position determination may be indicated when UE 100 has determined its position within some reference threshold time period from the initiation of STA-AP positioning If STA-AP position determination has not completed within the reference threshold time period of initiation of STA-AP positioning, then, STA-AP positioning may be deemed as unsuccessful.

If STA-AP location determination was not successful (“N” in block 740), then block 730 may be invoked, and UE 100 may determine its position using passive positioning. Upon completion of passive positioning in block 730, control may return to the calling routine if STA-AP location determination was successful (“Y” in block 735), then control may return to the calling routine.

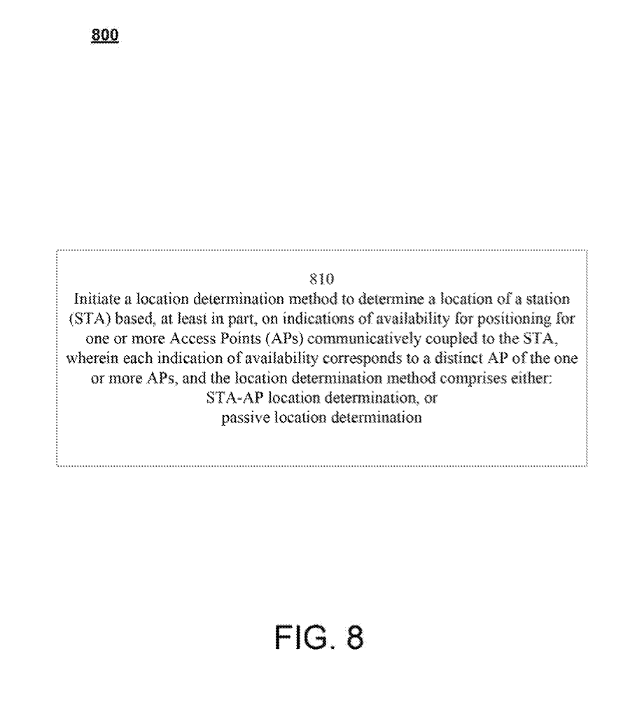

FIG. 8 shows an example flowchart for a method 800 to facilitate UE location determination. In some embodiments, method 800 may be performed on a STA such as UE 100 (e.g. by processor(s) 150).

In some embodiments, UE 100 may receive one or more management frames 600 and/or HE frame 610 from an AP 240 and method 800 may be performed, based, in part, on the information in management frames 600 and/or HE frame 610. For example, management frames 600 and/or HE frame 610 may include AP-AP performance field 609 or AP-AP performance field 629 or a Scheduling field, indicating a scheduled time for an AP-AP ranging/position session. In some embodiments, management frame 600 may further include one or more of: (i) a Load Element/extended Load Element; (b) STA-AP mode availability field 607 or STA-AP mode availability field 627; (c) AP capability field 608 or AP capability field 628. In some embodiments, Load Element/extended Load Element may be specified in a Basic Service Set (BSS) Load Element, or a Quality of Service (QoS) Basic Service Set (QBSS) Load Element.

In block 810, a location determination method to determine a location of a station (STA) may be initiated based, at least in part, on indications of availability for positioning for one or more Access Points (APs) communicatively coupled to the STA. Each indication of AP availability for positioning may correspond to a distinct AP of the one or more APs, and the location determination method may comprise either: STA-AP location determination, or passive location determination.

For example, block 810 may be performed on an apparatus (e.g. UE 100 of FIG. 1), which may include a transceiver and a processor (e.g. transceiver 110 or processor(s) 150 of FIG. 1) where the processor is configured to perform the function of block 810. In other embodiments, the apparatus may include a means for performing the functionality of block 810. Additionally, such an apparatus can further include a location determination means for determining a location of the STA, where the location determination means includes STA-AP location determination means for determining the location of the STA based on STA-AP location determination, and/or passive location determination means for determining the location of the STA based on passive location determination. For example, the means for performing the functions outlined in block 810, the means for performing other functionality described with reference to FIG. 8, the means for determining a location of the STA, the STA-AP location determination means for determining the location of the STA based on STA-AP location determination, and/or the passive location determination means for determining the location of the STA based on passive location determination may include, but are not limited to, antenna(s) 107, wireless network interface 105, transceiver 110, processor(s) 150, UE frame exchange engine 152, UE ranging engine 154, and/or UE positioning engine 156, connections 120, memory 130, and/or computer-readable medium 160, or any combination thereof.

For example, STA-AP location determination means for determining the location of the STA based on STA-AP location determination may include, but is not limited to, antenna(s) 107, wireless network interface 105, transceiver 110 (e.g. which, for example, may transmit signals to and/or receive signals from one or more APs 240), processor(s) 150. UE frame exchange engine 152, UE ranging engine 154, and/or UE positioning engine 156 which, for example, may process the transmitted and/or received signals), connections 120, memory 130, and/or computer-readable medium 160, or any combination thereof (which, for example, may be include instructions to perform one or more of the functions outlined above). As another example, passive location determination means for determining the location of the STA based on passive location determination may include, but is not limited to, antenna(s) 107, wireless network interface 105, transceiver 110 (which, for example, may passively listen to and receive signals exchanged between APs 240 and/or between other UEs and one or more APs 240), processor(s) 150, UE frame exchange engine 152, UE ranging engine 154, and/or UE positioning engine 156 (which, for example, may process the received signals), connections 120, memory 130, and/or computer-readable medium 160, or any combination thereof (which, for example, may be include instructions to perform one or more of the functions outlined above).

In some embodiments, for each of the one or more APs, the corresponding indication of availability for positioning may comprise information indicative of: availability of an STA AP positioning mode on the AP, or support for an STA-AP positioning capability on the AP, or availability of an AP-AP positioning mode on the AP, or support for an AP-AP positioning capability on the AP, or a current performance of AP-AP positioning by the AP, or a scheduled performance of AP-AP positioning on the AP, or some combination thereof. In some embodiments, for each AP, at least one of: the information indicative of support for the STA-AP positioning capability on the corresponding AP, or the information indicative of support for the AP-AP positioning capability on the corresponding AP, may be comprised in a capabilities field specifying the corresponding AP's capabilities.

In some embodiments, initiating the location determination method may comprise: determining, for each of the one or more APs, a corresponding Received Signal Strength Indication (RSSI); and selecting, based, at least in part, on the corresponding RSSIs, a subset of the one or more APs for the location determination method. In some embodiments, the location determination method may comprise passive location determination when a count of distinct APs in the subset that indicate availability of the STA AP positioning mode, or support for the STA-AP positioning capability does not exceed a threshold. For example, the threshold may be based on the desired positioning dimensionality (1D, 2D, 3D) desired by the UE. The location determination method may comprise the STA-AP location determination when the count of distinct APs in the subset that indicate availability of the STA AP positioning mode, or support for the STA-AP positioning capability exceeds the threshold.

In some embodiments, the method may further comprise: determining, for each AP in the subset, a corresponding AP load, wherein the corresponding AP load is determined based, at least in part, on one or more parameters comprised in a Basic Service Set (BSS) Load Element, or a Quality of Service Basic Service Set (QBSS) Load Element received from the AP. For example, the one or more parameters related to the AP load may comprise at least one of: a count of devices communicatively coupled to the AP; or information pertaining to a channel utilization for a communication channel between the STA and AP; or an available admission capacity; a current available AP bandwidth; a current AP bandwidth utilization; a measure network congestion; and/or some combination thereof.

In some embodiments, the indications of availability for positioning (e.g. in block 810) may be comprised in at least one of: beacon frames, or management frames, or probe response frames received by the STA from the one or more APs.

In some embodiments, for each AP in a subset of the one or more APs, the corresponding indication of availability for positioning (e.g. in block 810) may be based on a corresponding network load and/or AP load and/or channel load.

In some embodiments, the indication of AP load may be implicit. For example, the indication of AP load may be obtained, based on received information, from the AP, specifying at least one of: availability of STA-AP positioning on the AP (e.g. based on information in STA-AP field 607/627); or a support for STA-AP positioning on the AP (e.g. based on information in AP capability field 608/628).

In some embodiments, initiating the location determination method may comprise: determining, for each of the one or more APs, a corresponding AP load and/or corresponding channel load; and selecting, based, at least in part, on the corresponding AP load and/or the corresponding channel load, a subset of the one or more APs for the location determination method. In some embodiments, the subset of APs may be selected from those APs that indicate their corresponding AP load and/or their corresponding channel load does not exceed some load threshold. Further, the location determination method may comprise passive location determination when a count of distinct APs in the subset does not exceed some AP count threshold. For example, the AP count threshold may be based on the desired positioning dimensionality (1D, 2D, 3D) desired by the UE. The location determination method may comprise the STA-AP location determination when the count of distinct APs in the subset that indicate availability of the STA AP positioning mode, or support for the STA-AP positioning capability exceeds the AP count threshold.

In some embodiments, the subset of the one or more APs may be obtained based on corresponding RSSI levels and/or corresponding AP load and/or corresponding channel load.

In some embodiments, when the STA-AP positioning is initiated (e.g. in block 810) and in response to a determination that the STA-AP positioning has not completed within a reference threshold period of time following the initiation of the STA-AP positioning, passive positioning may be initiated. Accordingly, in some embodiments, a failure to complete STA-AP positioning within some reference threshold period of time of the STA-AP request may be viewed as an indication of high AP load. Thus, passive positioning may be performed (e.g. by UE/STA 100) when STA-AP positioning fails to complete within some reference threshold period of time from initiation of the STA-AP request.

FIG. 9 shows an example flowchart for a method 900 to facilitate UE location determination. In some embodiments, method 900 may be performed on a STA such as AP 240 (e.g. by processors 350).

In block 910, at a first time, the availability of an Access Point (AP) for positioning may be determined.

In block 920, the AP may transmit based at least in part, on the determination, information indicative of the AP's availability for positioning. In some embodiments, the information indicative of the AP's availability for positioning may comprise at least one of: STA-AP location determination availability, or STA-AP location determination capability, or one or more parameters related to AP load, or whether AP-AP positioning is being performed; or the next scheduled passive AP-AP ranging session; or some combination thereof. The indication of availability of the AP for positioning may be transmitted in one or more management frames 600 and/or HE packets 610.

For example, method 900 including blocks 910 and 920 may be performed on an apparatus (e.g. AP 240 of FIG. 3), which may include a transceiver and a processor (e.g. transceiver 390 or processor(s) 350 of FIG. 3) where the processor is configured to perform the functions outlined above. In other embodiments, the apparatus may include a means for performing the functionality of blocks 910 and 920. Additionally, such an apparatus (e.g. AP 240 can further include means for determining the availability of the AP for positioning and means for transmitting based at least in part, on the determination of availability information indicative of the AP's availability for positioning. For example, the means for performing the functions outlined in block 910, the means for performing other functionality described with reference to FIG. 9, the means for determining the availability of the AP for positioning and means for transmitting based at least in part, on the determination of availability information indicative of the AP's availability for positioning may include, but are not limited to, antenna(s) 305, transceiver 390, processer(s) 350, AP frame exchange engine 352, AP ranging engine 354, and/or AP positioning engine 356, connections 320, memory 330, and/or computer-readable medium 378, or any combination thereof.

In some embodiments, the availability of the AP for positioning (e.g. in block 910) may be determined based on network load, AP load and/or channel loads (for communication channels between AP 240 and communicatively coupled STAs).

In some embodiments, the transmitted information indicative of the availability of AP 240 for positioning (e.g. in block 920), may also be based, at least in part, on the determined AP load and may include information indicative of the AP load.

In some embodiments, AP 240 may transmit one or more management frames 600 and/or HE frame 610 with an indication of AP load. The indication of network load, AP load, and/or channel load transmitted by an AP may be implicit or explicit. For example, AP may indicate (e.g. implicitly), based on network load, AP load, and/or channel load, availability or non-availability of one or more modes of positioning. For example, management frames 600 and/or HE frame 610 may include one or more of: (a) AP-AP performance field 609 or AP-AP performance field 629 or (b) a Scheduling field, indicating a scheduled time for an AP-AP ranging/position session, (c) STA-AP mode availability field 607 or STA-AP mode availability field 627; (d) AP capability field 608 or AP capability field 628. In some embodiments, AP 240 may modify information in fields (a)-(d) to implicitly reflect load conditions by indicating performance, and/or availability (or non-availability) and/or support (or a lack of support) for one or more modes of positioning. Thus, in some embodiments, fields (a)-(d) above may include information indicative of a current AP load and/or an expected AP load.

In some embodiments, the indication of AP load may be (alternatively or additionally) provided through one or more parameters in a management, beacon, or probe response frame transmitted by the AP. In some embodiments, management frame 600 may further include a Load Element and/or an extended Load Element. In some embodiments, Load Element/extended Load Element may be specified in a Basic Service Set (BSS) Load Element, or a Quality of Service (QoS) Basic Service Set (QBSS) Load Element.

The network load and/or AP load and/or channel load may be determined or obtained by AP 240 based, at least in part, on one or more parameters including: the number of STAs communicatively coupled to the AP; or information pertaining to channel utilization or a channel load for a communication channel between the STA and AP; or an available admission capacity; a current available AP bandwidth; a current AP bandwidth utilization; a measure of network congestion; a pattern or history of AP load (e.g. based on time of day, and/or day of week) or some combination thereof. In some embodiments, some function of one or more of the above parameters related to AP load may be used to determine the AP load. As one example, if the number of STAs connected to the AP exceeds some specified number, then, the AP load may be determined to high, whereas, if the number of STAs connected to the AP does not exceed the specified number, then, the AP load may be determined to be low.

In some embodiments, if the AP load is determined to be high, relative to AP capacity or AP resources to support STA-AP positioning, then AP 240 may indicate one or more of: (a) non-availability of STA-AP positioning on the AP (e.g. using STA-AP field 607/627); or (b) a lack of current support for STA-AP positioning on the AP (e.g. using AP capability field 608/628); or (c) availability of AP-AP positioning (e.g. using AP-AP performance field 609 or AP-AP performance field 629 or (d) a Scheduling field, indicating a scheduled time or for an AP-AP ranging/position session. As another example, if the AP load is not determined to be high relative to AP capacity or AP resources to support STA-AP positioning based then AP 240 may indicate one or more of: availability of STA-AP positioning on the AP (e.g. using STA-AP field 607/627); (b) support for STA-AP positioning on the AP (e.g. using, AP capability field 608/628). In some embodiments, as outlined above, AP 240 may, alternatively or additionally, transmit one or more parameters related to the AP load (e.g. using a Load Element field or an extended Load Element field).

In some embodiments, when providing an indication of: non-availability of STA-AP positioning on the AP (e.g. using STA-AP field 607/627); or a lack of current support for STA-AP positioning on the AP (e.g. using AP capability field 608/628), AP may not turn off STA-AP positioning. Accordingly, AP 240 may transit information indicating non-availability or a lack of support for STA-AP positioning without turning off STA-AP positioning on AP 240. Thus, STA-AP positioning requests submitted prior to the time of indication of non-availability or a lack of support for STA-AP positioning may continue to be processed. In some embodiments, STA-AP positioning requests submitted after STA-AP positioning availability and/or capability has been turned off (e.g. by legacy devices) may be: (a) queued and processed when STA-AP positioning is subsequently turned on, or (b) may be refused or dropped, or (c) allowed to time out.

In some embodiments, based on the AP load, AP 240 may disable or enable STA-AP positioning. For example, AP 240 may periodically monitor changes to AP load or network load, and AP 240 may: (a) maintain a current indication of AP-load (e.g. availability/support for STA-AP positioning, or a lack of ability/support for STA-AP positioning); or update an indication of performance of AP-AP positioning and/or scheduled AP-AP positioning; or (c) update parameters related to AP load based on current values; or (d) enable availability/support for STA-AP positioning (if previously disabled); or (e) disable availability/support for STA-AP positioning (if previously enabled).

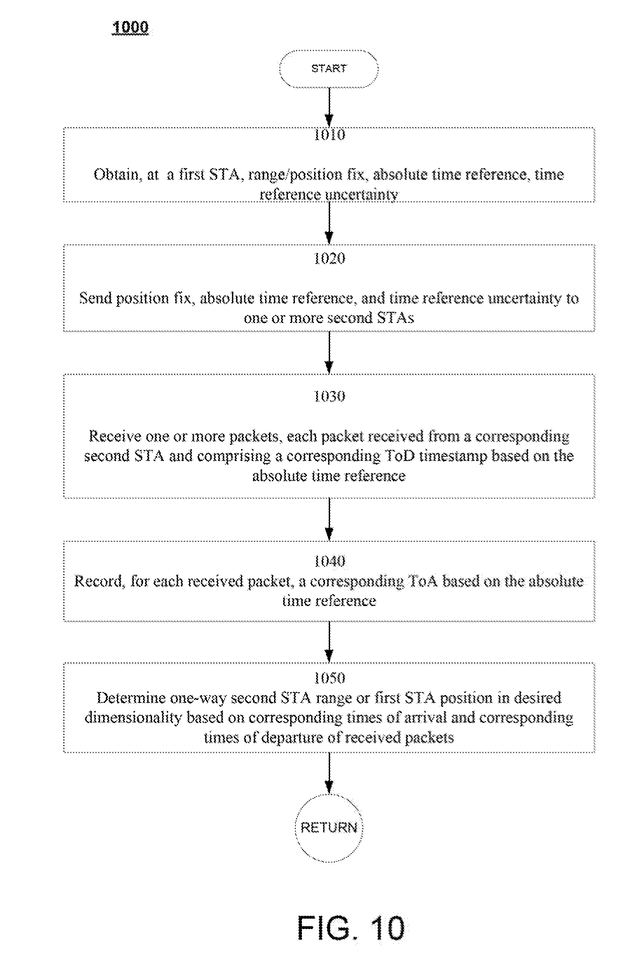

FIG. 10 shows an example flowchart illustrating a method 1000 for STA ranging/position determination. In some embodiments, method 1000 may be performed by a first STA (e.g. AP STA or non-AP STA). In some embodiments, method 1000 may be based, in part, on an absolute time reference and a time reference uncertainty.

In block 1010, a range or position fix, absolute time reference, and time reference uncertainty information may be obtained. In some embodiments, the range or position fix, absolute time reference, and time reference uncertainty information may be obtained (e.g. by the first STA) during negotiation phase 420 (in FIG. 4), or during/after measurement phase 430 (in FIG. 4). For example, the first STA may obtain ranging/position information based on STA-AP positioning (e.g. based on information obtained during measurement phase in FIG. 4). In some embodiments, the position fix, absolute time reference, and time reference uncertainty information may be obtained by the first STA as part of a separate procedure/protocol (e.g. separate from the example exchange shown in FIG. 4).

In embodiments where the first STA is UE 100, the absolute time reference and time reference uncertainty may be obtained by the STA/UE 100 from a SPS resource such as one or more of: a Global Navigation Satellite System (GNSS) Real Time Clock (RTC) or GNSS system time (e.g. the UE may include and/or be coupled to an GNSS receiver), CDMA system time from LTE System Information Block 8 (SIB8) message (e.g. received through transceiver 110); or GNSS system time from LTE System Information Block 16 (SIB16) message (e.g. received through transceiver 110).

In embodiments where the first STA is AP 240, the absolute time reference and time reference uncertainty may be obtained by the first STA/AP 240 based on signaling information received from another device (e.g. UE 100). In some embodiments, the first STA/AP 240 may modify the time reference uncertainty information to reflect various inaccuracies, processing delays and/or SIFS delays when appropriate.

In block 1020, the ranging/position information, absolute time reference and time reference uncertainty information may be sent to one or more second STAs (e.g. a requesting device/STA). For example, in embodiments where the first STA is UE 100, the first STA/UE 100 may send the ranging/position information, absolute time reference and time reference uncertainty information to one or more second STAs (e.g. APs 240). As another example, in embodiments where the first STA is AP 240, the first STA/AP 240 may send its position information, absolute time reference and time reference uncertainty information to one or more second STAs (e.g. UEs 100).

In block 1030, the first STA may receive packets/frames/messages from one or more second STAs. Each packet/frame/message received from a corresponding second STA may comprise a corresponding ToD timestamp (indicating the time the packet/frame/message was sent by the corresponding second STA) based on the absolute time reference.

In block 1040, the first STA may record ToA ((indicating the time the packet/frame/message was received by the first STA) based on the absolute time reference.

In block 1050, the first STA may determine the one-way range to the second STA and/or determine the first STAs position in desired dimensionality based on corresponding times of departure of the received packets and the corresponding times of arrival of the received packets. For example, in embodiments where the first STA is an AP 240, then, the first STA/AP 240 may determine the range of second STA (e.g. UEs 100) based on the corresponding times of departure of the received packets and the corresponding times of arrival of the received packets. As another example, in embodiments where the first STA is UE 100, in a quasi-synchronized network (e.g. where several APs 240 use the absolute time reference), the first STA/UE 100 may determine is position in the desired dimensionality based on the corresponding timing information (based on the absolute reference time) in the received packets/frames/messages.

For example, method 1000 may be performed on an apparatus (e.g. UE 100 of FIG. 1), which may include a transceiver and a processor (e.g. transceiver 110 or processor(s) 150 of FIG. 1) where the processor is configured to perform the function of block 810. In other embodiments, the apparatus may include a means for performing the functionality of block 810. Additionally, such an apparatus can further include: a means for obtaining range/position fix, absolute time reference, and time reference uncertainty information, means for sending a position fix, the absolute time reference, and the time reference uncertainty information (e.g. to one or more second STAs), means for receiving one or more packets, wherein each packet is received from a corresponding second STA and comprises a corresponding ToD timestamp based on the absolute time reference, means for recording, for each received packet, a corresponding ToA based on the absolute time reference, means for determining one-way second STA range or first STA position in the desired dimensionality based on corresponding times of arrival and corresponding times of departure of received packets. For example, the means for performing the functions outlined in blocks 1010 through 1050, the means for performing other functionality described with reference to FIG. 10, means for obtaining range/position fix, absolute time reference, and time reference uncertainty information, means for sending a position fix, the absolute time reference, and the time reference uncertainty information (e.g. to one or more second STAs), means for receiving one or more packets, wherein each packet is received from a corresponding second STA and comprises a corresponding ToD timestamp based on the absolute time reference, means for recording, for each received packet, a corresponding ToA based on the absolute time reference, means for determining one-way second STA range or first STA position in the desired dimensionality based on corresponding times of arrival and corresponding times of departure of received packets may include, but are not limited to, antenna(s) 107, wireless network interface 105, transceiver 110, processor(s) 150, UE frame exchange engine 152, UE ranging engine 154, and/or UE positioning engine 156, connections 120, memory 130, and/or computer-readable medium 160, or any combination thereof.

Although the disclosure is illustrated in connection with specific embodiments for instructional purposes, embodiments are not limited thereto. Various adaptations and modifications may be made without departing from the scope. Therefore, the spirit and scope of the appended claims should not be limited to the foregoing description.

What is claimed is:

1. A method comprising, at a Station (STA):
initiating a location determination method to determine a location of the STA based, at least in part, on indications of availability for positioning for one or more Access Points (APs) communicatively coupled to the STA, wherein each indication of availability corresponds to a distinct AP of the one or more APs, and the location determination method comprises at least one of:
STA-AP location determination, or
passive location determination.

2. The method of claim 1, wherein, for each of the one or more APs, the corresponding indication of availability for positioning comprises information indicative of:
availability of an STA-AP positioning mode on the AP, or
support for an STA-AP positioning capability on the AP, or
availability of an AP-AP positioning mode on the AP, or
support for an AP-AP positioning capability on the AP, or
a current performance of AP-AP positioning by the AP, or
a scheduled performance of AP-AP positioning on the AP, or
some combination thereof.

3. The method of claim 2, wherein at least one of: the information indicative of support for the STA-AP positioning capability an the AP, or the information indicative of support for the AP-AP positioning capability on the AP, is comprised in a capabilities field specifying corresponding AP capabilities.

4. The method of claim 2, wherein initiating the location determination method comprises:
determining, for each of the one or more APs, a corresponding Received Signal Strength Indication (RSSI); and
selecting, based, at least in part, on the corresponding RSSIs, a subset of the one or more APs for the location determination method.

5. The method of claim 4, wherein:
the location determination method comprises the passive location determination when a count of distinct APs in the subset that indicate availability of the STA-AP positioning mode, or support for the STA-AP positioning capability, does not exceed a threshold; or
the location determination method comprises the STA-AP location determination when the count of distinct APs in the subset that indicate availability of the STA-AP positioning mode, or support for the STA-AP positioning capability, exceeds the threshold.

6. The method of claim 4, further comprising:
determining, for each AP in the subset, a corresponding AP load, wherein the corresponding AP load is determined based, at least in part, on one or more parameters comprised in a Basic Service Set (BSS) Load Element, or a Quality of Service Basic Service Set (QBSS) Load Element received from the AP.

7. The method of claim 6, wherein the one or more parameters related to the AP load comprise at least one of:
a count of devices communicatively coupled to the AP; or
information pertaining to a channel utilization for a communication channel between the STA and AP; or
an available admission capacity;
a current available AP bandwidth;
a current AP bandwidth utilization;
a measure of network congestion; or
some combination thereof.

8. The method of claim 1, wherein the indications of availability for positioning are comprised in at least one of: beacon frames, or management frames, or probe response frames received by the STA from the one or more APs.

9. The method of claim 1, wherein, for each AP in a subset of the one or more APs, the corresponding indication of availability for positioning is based on a corresponding AP load.

10. The method of claim 1, further comprising:
when the STA-AP positioning is initiated and in response to a determination that the STA-AP positioning has not completed within a reference threshold period of time following the initiation of the STA-AP positioning:
initiating passive positioning.

11. A station (STA) comprising:
a transceiver, and
a processor coupled to the transceiver, wherein the processor is configured to:
initiate location determination to determine a location of the STA based, at least in part, on indications of availability for positioning for one or more Access Points (APs) communicatively coupled to the STA, wherein each indication of availability corresponds to a distinct AP of the one or more APs, and the location determination comprises at least one of:
STA-AP location determination, or
passive location determination.

12. The STA of claim 1, wherein, for each of the one or more APs, the corresponding indication of availability for positioning comprises information indicative of:
availability of an STA-AP positioning mode on the AP, or
support for an STA-AP positioning capability on the AP, or
availability of an AP-AP positioning mode on the AP, or
support for an AP-AP positioning capability on the AP, or
a current performance of AP-AP positioning by the AP, or
a scheduled performance of AP-AP positioning on the AP, or
some combination thereof.

13. The STA of claim 1, wherein at least one of: the information indicative of support for the STA-AP positioning capability on the AP, or the information indicative of support for the AP-AP positioning capability on the AP, is comprised in a capabilities field specifying corresponding AP capabilities.

14. The STA of claim 12, wherein to initiate the location determination, the processor is configured to:
determine, for each of the one or more APs a corresponding Received Signal Strength Indication (RSSI); and
select, based, at least in part, on the corresponding RSSIs, a subset of the one or more APs for the location determination.

15. The STA of claim 14, wherein:
the location determination comprises the passive location determination when a count of distinct APs in the subset that indicate availability of the STA-AP positioning mode, or support for the STA-AP positioning capability, does not exceed a threshold; or
the location determination comprises the STA-AP location determination when the count of distinct APs in the subset that indicate availability of the STA-AP positioning mode, or support for the STA-AP positioning capability, exceeds the threshold.

16. The STA of claim 14, wherein the processor is further configured to:
determine, for each AP in the subset, a corresponding AP load, wherein the corresponding AP load is determined based, at least in part, on one or more parameters comprised in a Basic Service Set (BSS) Load Element, or a Quality of Service Basic Service Set (QBSS) Load Element received from the AP.

17. The STA of claim 16, wherein the one or more parameters related to the AP load comprise at least one of:
a count of devices communicatively coupled to the AP; or
information pertaining to a channel utilization for a communication channel between the STA and AP; or
an available admission capacity;
a current available AP bandwidth;
a current AP bandwidth utilization;
a measure of network congestion; or
some combination thereof.

18. The STA of claim 11, wherein the indications of availability for positioning are comprised in at least one of beacon frames, or management frames, or probe response frames received by the STA from the one or more APs.

19. The STA of claim 11, wherein, for each AP in a subset of the one or more APs, the corresponding indication of availability for positioning is based on a corresponding AP load.

20. The STA of claim 11, wherein:
when the STA-AP positioning is initiated and in response to a determination that the STA-AP positioning has not completed within a reference threshold period of time following the initiation of the STA-AP positioning, the processor is further configured to
initiate passive positioning.

21. A station (STA) comprising:
means for initiating a location determination means for determining a location of the STA based, at least in part, on indications of availability for positioning for one or more Access Points (APs) communicatively coupled to the STA, wherein each indication of availability corresponds to a distinct AP of the one or more APs; and
the location determination means comprising at least one of: STA-AP location determination means for determining the location of the STA based on STA-AP location determination, or passive location determination means for determining the location of the STA based on passive location determination.

22. The STA of claim 21, wherein, for each of the one or more APs, the corresponding indication of availability for positioning comprises information indicative of:
availability of an STA-AP positioning mode on the AP, or
support for an STA-AP positioning capability on the AP, or
availability of an AP-AP positioning mode on the AP, or
support for an AP-AP positioning capability on the AP, or
a current performance of AP-AP positioning by the AP, or
a scheduled performance of AP-AP positioning on the AP, or
some combination thereof.

23. The STA of claim 22, wherein at least one of: the information indicative of support for the STA-AP positioning capability on the AP, or the information indicative of support for the AP-AP positioning capability on the AP, is comprised in a capabilities field specifying corresponding AP capabilities.

24. The STA of claim 22, wherein the means for initiating the location determination means comprises:
means for determining, for each of the one or more APs, a corresponding Received Signal Strength Indication (RSSI); and
means for selecting, based, at least in part, on the corresponding RSSIs, a subset of the one or more APs for use by the location determination means.

25. The STA of claim 24, wherein:
the location determination means comprises the passive location determination means when a count of distinct APs in the subset that indicate availability of the STA-AP positioning mode, or support for the STA-AP positioning capability does not exceed a threshold; or
the location determination means comprises the STA-AP location determination means when the count of distinct APs in the subset that indicate availability of the STA-AP positioning mode, or support for the STA-AP positioning capability exceeds the threshold.

26. A non-transitory computer-readable medium comprising instructions to configure a processor on a station (STA) to:
initiate a location determination method to determine a location of the STA based, at least in part, on indications of availability for positioning for one or more Access Points (APs) communicatively coupled to the STA, wherein each indication of availability corresponds to a distinct AP of the one or more APs, and the location determination method comprises either:
STA-AP location determination, or
passive location determination.

27. The computer-readable medium of claim 26, wherein, for each of the one or more APs, the corresponding indication of availability for positioning comprises information indicative of:
availability of an STA-AP positioning mode on the AP, or
support for an STA-AP positioning capability on the AP, or
availability of an AP-AP positioning mode on the AP, or
support for an AP-AP positioning capability on the AP, or
a current performance of AP-AP positioning by the AP, or
a scheduled performance of AP-AP positioning on the AP, or
some combination thereof.

28. The computer-readable medium of claim 27, wherein to initiate the location determination method, the processor is configured to:
determine, for each of the one or more APs, a corresponding Received Signal Strength Indication (RSSI); and
select, based, at least in part, on the corresponding RSSIs, a subset of the one or more APs for the location determination method.

29. The STA of claim 28, wherein:
the location determination method comprises the passive location determination when a count of distinct APs in the subset that indicate availability of the STA-AP positioning mode, or support for the STA-AP positioning capability, does not exceed a threshold; or
the location determination method comprises the STA-AP location determination when the count of distinct APs in the subset that indicate availability of the STA-AP positioning mode, or support for the STA-AP positioning capability exceeds the threshold.

30. The STA of claim 28, wherein the processor is further configured to:
determine, for each AP in the subset, a corresponding AP load, wherein the corresponding AP load is determined based, at least in part, on one or more parameters comprised in a Basic Service Set (BSS) Load Element, or a Quality of Service Basic Service Set (QBSS) Load Element received from the AP.
